(19) United States
(12) Patent Application Publication
(10) Pub. No.: US 2026/0003996 A1
(43) Pub. Date: Jan. 1, 2026

(54) CONSISTENCY FOR QUERIES IN PRIVACY-PRESERVING DATA ANALYTIC SYSTEMS

(71) Applicant: Microsoft Technology Licensing, LLC, Redmond, WA (US)

(72) Inventors: Mark B. Cesar, Oakland, CA (US); Praveen K. Chaganlal, Santa Clara, CA (US); Yu Chen, Santa Clara, CA (US); Tin Yam Ho, Belmont, CA (US); Ryan M. Rogers, Los Gatos, CA (US); Adrian Rivera Cardoso, San Francisco, CA (US); Subbu Subramaniam, San Jose, CA (US); Siyao Sun, Santa Clara, CA (US); Rahul Tandra, Santa Clara, CA (US); Xinlin Zhou, San Jose, CA (US)

(21) Appl. No.: 18/758,709

(22) Filed: Jun. 28, 2024

(51) Int. Cl. G06F 21/62; G06F 16/22

(52) U.S. Cl. CPC G06F 21/6245; G06F 16/2282; G06F 21/6227

(57) ABSTRACT

Techniques for executing privacy-preserving aggregation queries on a database table include receiving a query, obtaining the true output, and generating deterministic pseudorandom noise based on the query and current database state. This noise is added to the true output to create a privacy-protected result. For subsequent queries, this process is repeated, potentially with updated state data, ensuring that privacy protection adapts to changes in the underlying data. The approach maintains consistency for repeated queries on unchanged data while providing fresh noise when data changes. It balances privacy protection with data utility, allowing for various query types while guarding against privacy attacks. The techniques include displaying the noisy output to a user interface. The techniques offer adaptive privacy protection, query flexibility, and efficient resource utilization, making them suitable for dynamic data environments requiring both privacy and analytical capabilities.

### BACKGROUND

Preserving user privacy is a requirement for many web-scale data mining applications and systems, such as web search engines, recommender systems, crowdsourced platforms, and analytics applications. This necessity has gained renewed importance due to recent privacy regulations. Online social media and web platforms provide various analytics and reporting tools for their users. These tools include ad analytics (key campaign performance metrics across different demographic dimensions), content analytics (aggregated demographics of users viewing a creator's content), and profile view statistics (details on who viewed a user's profile, aggregated by profession and industry). For these analytics applications, maintaining member privacy is essential, as actions taken by users can be considered sensitive information. Specifically, it is important to ensure that no individual's actions (e.g., clicking on an article or ad) can be deduced from the analytics system's results. Additionally, practical considerations must be addressed to ensure the product remains viable and user-friendly.

### BRIEF DESCRIPTION OF THE DRAWINGS

The following detailed description of certain embodiments of the invention are understood by reference to the following figures:

FIG. 1 illustrates a privacy-preserving multi-user application system, according to some embodiments of the present disclosure.

FIG. 2 is a black box view of a deterministic, pseudorandom noise generation algorithm, according to some embodiments of the present disclosure.

FIG. 3 illustrates an example pseudocode implementation of a deterministic, pseudorandom noise generation algorithm, according to some embodiments of the present disclosure.

FIG. 4 illustrates a black box view of a noisy output computation algorithm, according to some embodiments of the present disclosure.

FIG. 5 illustrates an example pseudocode implementation of a noisy output computation algorithm, according to some embodiments of the present disclosure.

FIG. 6 is a black box view of a deterministic, pseudorandom noise generation algorithm that incorporates database state data, according to some embodiments of the present disclosure.

FIG. 7 illustrates an example pseudocode implementation of a deterministic, pseudorandom noise generation algorithm that incorporates database state data, according to some embodiments of the present disclosure.

FIG. 8 illustrates a method for consistency for queries in privacy-preserving data analytic systems, according to some embodiments of the present disclosure.

FIG. 9 illustrates an example multi-user application system in which the techniques disclosed herein for consistency for queries in privacy-preserving data analytic systems are implemented, according to some embodiments of this disclosure.

FIG. 10 illustrates an example of a programmable electronic device that processes and manipulates data to perform the techniques disclosed herein for consistency for queries in privacy-preserving data analytic systems, according to some embodiments of this disclosure.

### DETAILED DESCRIPTION

Systems, methods, and non-transitory computer-readable media (collectively referred to herein as “techniques”) are disclosed for consistency for queries in privacy-preserving data analytic systems.

In an embodiment, the techniques encompass a process for executing aggregation queries on a database table while incorporating differential privacy techniques that adapt to potential changes in the underlying data. This method is designed to handle both initial and subsequent queries, accounting for possible alterations in the database state between query executions.

The process begins by receiving an aggregation query of a predetermined type targeting a specific database table. It then obtains the true output by executing this query against the table. The method determines a first deterministic pseudorandom noise value based on both the query itself and the current state of the data in the table. This state data reflects the condition of the database at the time of query execution, allowing the noise generation to be sensitive to the data's current characteristics. The method then combines the true output with this noise to produce a noisy output, which helps preserve privacy by obscuring the exact query results.

The method then accounts for subsequent queries by following a similar process for an additional aggregation query. It obtains a new true output and determines new state data reflecting any potential changes in the database since the first query. This updated state data is used along with the new query parameters to generate a second deterministic pseudorandom noise value. This approach ensures that the noise added to query results remains appropriate and effective even if the underlying data has changed significantly. The method concludes by determining a second noisy output based on this new noise value and displaying it in a graphical user interface.

This approach provides a balance between query result consistency and adaptive privacy protection. By incorporating current state data into the noise generation process, the method can maintain effective differential privacy even as the database contents evolve over time, while still providing deterministic results for identical queries if the database hasn't changed. This makes it particularly suitable for scenarios where data may be frequently updated (e.g., once a day) but where consistent query results are also desirable for unchanged data states.

Additionally, according to some embodiments, the method described offers an innovative approach to maintaining privacy while allowing for repeated queries without automatically reducing the privacy budget when the underlying data remains unchanged. This is achieved through the use of deterministic pseudorandom noise that is based not only on the query parameters but also on the state of the database at the time of query execution.

In some embodiments, the privacy budget may be a component representing the total amount of privacy loss that is acceptable for a dataset, a series of queries, a user or other querier, or other entity. In conventional differential privacy implementations, each query consumes a portion of the privacy budget. Once this budget is exhausted, no further queries can be executed without risking privacy breaches. This approach often leads to a trade-off between the number of queries that can be performed and the accuracy of the results, as the privacy budget must be carefully allocated across all expected queries.

According to the disclosed techniques, the method uses deterministic pseudorandom noise based on both the query or the query parameters and the current database state such that the method can provide consistent results for identical queries on unchanged data without necessarily reducing the privacy budget. Thus, repeated queries are possible without the conventional privacy budget depletion, as long as the underlying data remains constant. The method enhances the utility of privacy-preserving data analytics systems, allowing for more flexible and extensive querying while maintaining strong privacy guarantees.

When a query is repeated and the underlying database data has not changed, the method will generate the same deterministic pseudorandom noise value. This is because both the query parameters (which are identical for a repeated query) and the state data (which reflects the unchanged database state) remain the same. As a result, the noise added to the true query result will be identical to that added in the previous execution of the same query.

This approach effectively prevents the reduction of the privacy budget for repeated queries on unchanged data because it doesn't require the addition of new, independent noise for each query execution. In some conventional differential privacy systems, each query execution typically consumes some portion of the privacy budget, even if the query and data are unchanged, as new random noise is generated each time. In contrast, this method's use of deterministic noise based on both query and data state allows for consistent results without additional privacy cost when the data hasn't changed.

An aspect to this privacy preservation lies in the method's ability to tie the noise generation to the current state of the database. If an attacker were to issue the same query multiple times in an attempt to average out the noise and approximate the true value, they would receive the same noisy result each time, as long as the underlying data remains unchanged. This consistency prevents the kind of statistical attacks that repeated queries with independent noise might be vulnerable to.

However, it is important to note that this method also adapts when the data does change. If a subsequent query is executed after the database has been updated, the state data will reflect these changes, leading to the generation of a different noise value. This ensures that the privacy protection remains effective even as the database evolves over time.

Large-scale Internet companies may utilize diverse analytics and reporting systems as part of their product offerings. These systems may include an ad campaign analytics platform for advertisers, a content analytics platform for content creators, and a profile view analytics platform for users. An objective of these platforms is to present performance metrics related to user activity on various items (e.g., ads, articles, posts, user profiles), providing valuable insights to platform users. For instance, an advertiser can assess the effectiveness of an ad campaign across different professions, functions, companies, and locations. A content creator can understand the aggregated demographics of users viewing their content, and a user can see which professions, functions, companies, and locations contribute most to their profile views. These platforms are typically accessible via a web interface displaying relevant statistics (e.g., impressions, clicks, shares, conversions, profile views, and demographic breakdowns) over time. Additionally, they may also be available through corresponding APIs, such as an ad analytics API.

A characteristic of these analytics platforms can be their restriction to a limited set of predetermined query types through their user interfaces and APIs, unlike standard statistical databases that permit arbitrary statistical queries. For example, the platforms allow queries for the count of user actions over a specified time period, along with top demographic breakdowns. An example representation of such a statistical query (sometimes referred to as an “aggregation” query”) is:
SELECT COUNT(*) FROM table(statType, entity) WHERE timeStamp >=startTime AND timeStamp <=endTime AND dattr=dval

Here, table(statType, entity) represents a table where each row corresponds to a user action (event) of a specific statistics type (statType) for an entity (e.g., clicks on a given ad or post). The demographic attribute (dattr) and its desired value (dval) (e.g., “Senior Director”) are specified as conditions. In a practical implementation, these events can be preprocessed and stored in a partially aggregated form, with each row representing the number of actions for a specific combination of statType, entity, dattr, dval, and the most granular time range. The query then sums the number of user actions that meet the specified conditions for time range and demographic attribute-value pairs.

The disclosed techniques preserve the privacy of users of large-scale Internet platforms with analytic and reporting features, ensuring that an attacker cannot deduce whether a specific user performed an action (e.g., clicking on an article or ad) by analyzing the results provided by the analytics and reporting system over time. It is assumed that the attacker may possess information about the target user's attributes (e.g., from the user's public or shared profile data) and knowledge of other users who performed similar actions (e.g., through the use of fake accounts controlled by the attacker).

Aggregate analytics can still potentially reveal information about individual users' actions. For instance, consider an ad campaign targeting “Senior Directors in the US who studied at the University of California.” While this campaign may include thousands of users, it might match only one user within a specific company, whose identity can be inferred from the user's profile or a targeted search. Consequently, company-level demographic breakdowns of ad clicks could expose whether this user clicked on the ad. A common mitigation strategy involves using a deterministic minimum threshold k before displaying statistics. However, if an attacker creates k−1 or more fake accounts matching the same criteria and orchestrates clicks from these accounts, they can determine whether the target user clicked on the ad based on company-level ad click counts. Increasing the threshold merely raises the attacker's effort but does not eliminate the attack risk.

To ensure incremental privacy protection, it is important to guard against attacks based on observations over time. For example, a malicious advertiser might infer the identity of a user who clicked on an ad by monitoring reported ad analytics over consecutive days. Consider an ad campaign targeting “all professionals in the United States with skills in ‘leadership’ and ‘management’ and at least 15 years of experience.” If this ad initially receives numerous clicks from leadership professionals across companies and subsequently, on a later day, receives a single click that increases the ‘title=CEO’ and ‘company=ACME’ counts by one each, the advertiser can deduce that ACME's CEO clicked on the ad by comparing daily counts. These scenarios underscore the necessity of implementing rigorous techniques to preserve user privacy in analytics applications, preventing the revelation of exact aggregate counts while still maintaining utility and data consistency. Techniques disclosed herein address these issues.

For an analytics and reporting platform to be viable and useful, it is important that the aggregate statistics are available and reasonably accurate across a broad range of action types, entities, demographic attribute/value combinations, and time ranges. This coverage and utility ensure that the platform provides comprehensive and meaningful insights for various analytics applications.

In the context of an analytics platform, data consistency is also important, especially when true counts cannot be displayed due to privacy requirements. One desirable property is consistency for repeated queries where the reported answer should remain unchanged when the same query is repeated, provided the true output has not changed. For instance, the reported number of clicks on a specific article for a past date should remain consistent across subsequent queries. Techniques disclosed herein provide consistency for repeated queries while at the same time preserving user privacy while still maintaining utility.

### Privacy-Preserving Multi-User Application System

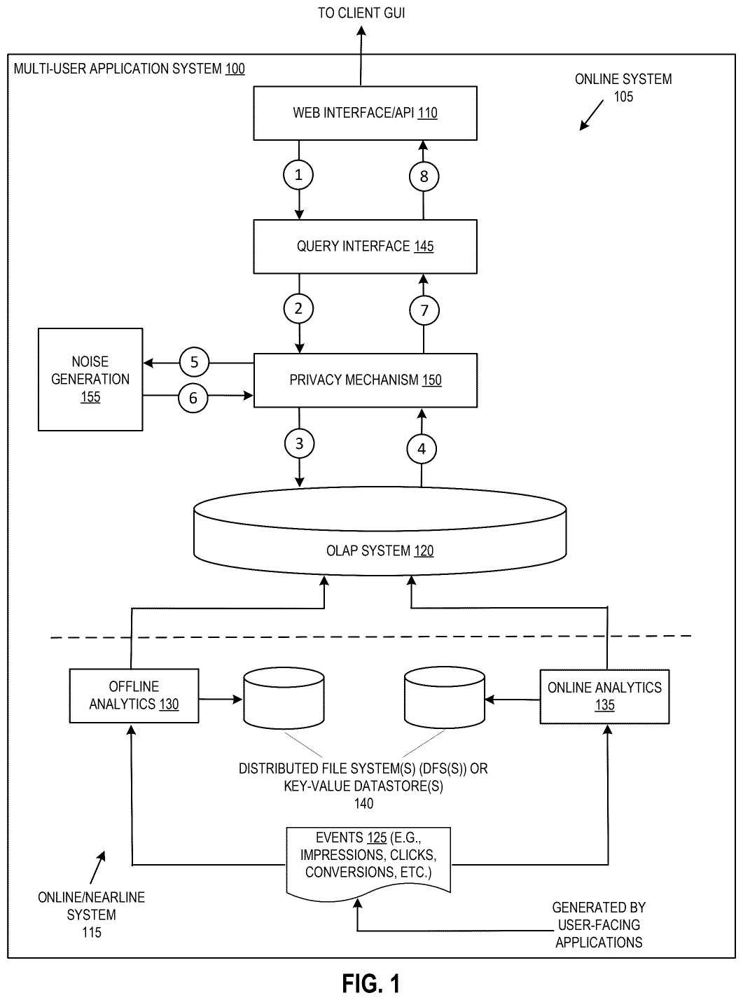

FIG. 1 illustrates a privacy-preserving multi-user application system 100, according to some embodiments of the present disclosure. The system 100 encompasses an online system 105 providing an interactive interface (or API) 110 for displaying various analytics about user actions at client graphical user interfaces (GUIs), and an online/nearline system 115 generating the required tables of an online analytical processing (OLAP) system 120 containing granular member actions (events).

The tables for computing different analytics about member actions are stored in OLAP system 120, a real-time distributed OLAP datastore designed for delivering low-latency, scalable real-time analytics. Two workflows orchestrated by the online/nearline system 115 process raw event data, including messages generated from user-facing applications (such as impressions and actions like clicks and conversions), and compute partially aggregated analytics, which are then ingested into the OLAP system 120. Each such message may be a discrete unit of data that is produced by a “producer” application of the multi-user application system 100 and consumed by one or more “consumers” of the multi-user application system 100. Each message may contain a key, a value, and optionally, metadata headers and may be stored in or associated with a publish-subscription topic or channel.

The first workflow orchestrated by the offline system 130 of the online/nearline system 115 operates at a particular frequency (e.g., daily) in an offline mode to compute the previous day's analytics and store them in a distributed file system or key-value datastore 140. The second workflow orchestrated by online analytics system 135 of the online/nearline system 115 operates more frequently (e.g., every few hours) in an online/nearline mode to compute intra-day incremental changes that are stored in a distributed file system or key-value datastore 140. The data ingested into the OLAP system 120 includes key fields such as granular time ranges, entity (and its hierarchy, if applicable), demographic attributes and values, and various action counts. This fine-grained data stored in the OLAP system 120 is aggregated by the online system 105 based on analytics requests from the web interface or API 110.

The online system 105 employs a service-oriented architecture for retrieving and presenting privacy-preserving analytics about user actions in response to requests from the user-facing product (web interface) or API 110. A request is first sent to a query interface component 145 (step 1), which processes and transforms it into underlying database queries, then forwards them to the privacy mechanism component 150 (step 2). This component fetches the true answers to these queries from the OLAP system 120 (steps 3 & 4), generates 155 the appropriate noise (steps 5 & 6), performs post-processing consistency checks using an algorithm described in greater detail herein, and returns the noisy counts (step 7) to the calling service (step 8).

While in some embodiments noisy counts are returned to the calling service, the techniques are implemented to return other types of noisy aggregation values for other types of query aggregation functions (other than COUNT( )) such as any of SUM( ), AVGO, MIN( ), MAX( ), VAR( ) or VARIANCE( ), STDEV( ) or STDDEV( ), GROUPING( ), GROUPING_ID( ), or any other suitable query aggregation function. Thus, while examples herein feature noisy counts and the COUNT( ) query aggregation function, it should be understood that the techniques are not limited to those examples and that the techniques can be used with any suitable query aggregation function that outputs a value or a set of values that is combinable with a noise value to yield a noisy output.

### Privacy Model and Algorithms

The disclosed techniques encompass a privacy model and algorithms for privacy protection in an analytics and reporting context. The techniques utilize a random noise addition mechanism (e.g., noise generation 155) based on differential privacy principles. Differential privacy provides a formal guarantee that ensures the privacy of individuals when aggregate statistical information about a group is released. The key requirement of differential privacy is that the probability distribution of the published results remains nearly unchanged, regardless of whether an individual's data is included in the dataset. This ensures that an attacker gains minimal additional information about any specific individual from the released statistics. The disclosed techniques modify the reported aggregate counts by adding random noise, adhering to this principle to protect individual privacy.

The differential privacy principles adhere to the following definitions and theorem.

Definition 1: A randomized mapping K satisfies ε—differential privacy if for all pairs of datasets (D, D′) differing in at most one row, and all S contained in Range(K),

Pr[K(D)∈S]≤e^{ε}·Pr[K(D′)∈S],

Where the probability is over the coin flips of K.

To satisfy Definition 1, the techniques add noise (e.g., from a Laplace distribution) to the true result of a statistical query function. This function could represent, for example, the number of members who clicked on an article or the histogram of titles of those members. The amount of noise added is determined by the L₁ sensitivity of the query, which is the maximum change in the query output when a single member is added or removed from the dataset. Additionally, the level of noise is influenced by the desired privacy guarantee, represented by the parameter epsilon (e). The noisy result is then released, ensuring that individual privacy is preserved while providing useful aggregate data.

Definition 2: The L₁ sensitivity of a query function, ƒ: D à R^{d} is defined as:
Δ(ƒ)=max_{D,D′}∥ƒ(D)−F(D′)∥₁, for all pairs of datasets (D, D′) different in at most one row.

Theorem 1: Given a query function ƒ: D à R^{d}, the randomized mechanism K that adds noise drawn independently from the noise distribution (e.g., Laplace distribution) with parameter

$$\frac{Δ ( f )}{ε}$$

to each of the d dimensions of ƒ(D) satisfies ε—differential privacy.

Noise can be added from other types of distributions (e.g., other than a Laplace distribution) according to the requirements of the particular implementation at hand. For example, some possible alternatives to using a Laplace distribution for adding noise in differential privacy include:

Gaussian Distribution: Noise is added based on the Gaussian (normal) distribution. This method may be used in the context of (ε, δ)-differential privacy, which provides a relaxation of pure differential privacy and can offer better accuracy under certain conditions.

Exponential Distribution: This may be useful in specific types of differential privacy mechanisms like the exponential mechanism, which selects an output from a set of possible outputs based on a probability distribution weighted by a utility function.

These alternatives can be chosen based on the specific requirements of the differential privacy application, such as the desired level of privacy, the nature of the data, and the computational efficiency.

There are also possible alternatives to using the L₁ sensitivity of the query. Some possible alternatives include:

L₂ Sensitivity: Also known as the Euclidean sensitivity, L₂ sensitivity measures the maximum change in the query result in terms of the Euclidean distance when a single individual's data is added or removed. This may be useful when using the Gaussian distribution for noise addition, as it aligns with the properties of the Gaussian mechanism.

Global Sensitivity: This general term refers to the maximum change in the query result across all possible datasets of a given size. L₁ and L₂ sensitivities are specific types of global sensitivity, but the concept can be extended to other norms and measures.

Local Sensitivity: Local sensitivity considers the sensitivity of the query with respect to the actual dataset in use, rather than the worst-case scenario across all possible datasets. This can sometimes allow for tighter bounds on the added noise, although it may be more complex to compute and implement.

Smooth Sensitivity: A refinement of local sensitivity, smooth sensitivity provides a way to add noise that adapts to the local sensitivity of the dataset while maintaining robustness to small changes in the dataset. It ensures that the added noise is not only based on the specific dataset but also on nearby datasets, providing a balance between global and local sensitivity.

Rènyi Differential Privacy (RDP): This framework generalizes differential privacy by using Rènyi divergence, a measure of the difference between two probability distributions. It provides a different perspective on sensitivity and privacy guarantees, potentially offering more flexibility in certain applications.

These alternatives can be chosen based on the specific requirements of the privacy mechanism, the nature of the data, and the desired balance between privacy protection and utility.

According to some embodiments, the techniques implement event-level differential privacy, which aims to conceal the presence or absence of a single event, specifically any single action performed by any member. Within this framework, the sensitivity of the example query in the overview section above is equal to 1. This means that the maximum change in the output of the query, when one event is added or removed from the dataset, is 1. This approach ensures that the privacy protection focuses on individual actions, maintaining the privacy of each member's specific activity.

### Pseudorandom Noise Generation

A limitation of a conventional differential privacy approach is that repeated queries can average out the added random noise, compromising privacy. To address this and ensure consistent responses to repeated queries, the techniques use deterministic, pseudorandom noise generation algorithm. This algorithm assigns a fixed noise value to a specific query, ensuring that the same query always receives the same noise.

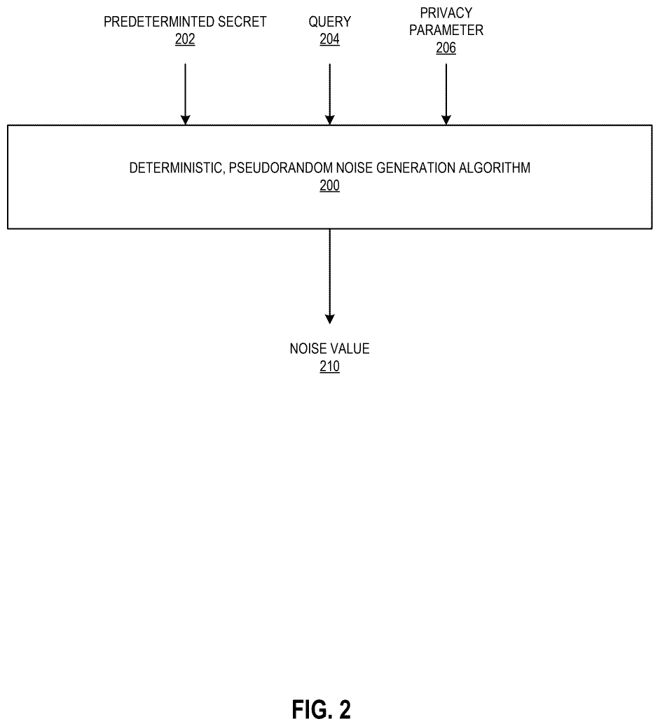

In an embodiment, the techniques generate a pseudorandom noise from a noise distribution (e.g., the Laplace distribution). FIG. 2 is a black box view of a deterministic, pseudorandom noise generation algorithm 200, according to some embodiments of the present disclosure. As illustrated in FIG. 2, this involves inputting a predetermined secret 202, the statistical query 204, and the desired privacy parameter 206 into a noise generator 200. The secret 202 and query 204 are processed by a deterministic function of the noise generator 200, which returns a pseudorandom fraction between 0 and 1. This fraction, treated as a sample from the uniform distribution on (0, 1), is used to compute the pseudorandom noise through the inverse cumulative distribution function (CDF) of a noise distribution (e.g., the Laplace distribution). The noise is then rounded to the nearest integer for reporting as noise value 210.

The deterministic function of the noise generator 200 which returns a pseudorandom fraction between 0 and 1 given the predetermined secret 202 and query 204 can be implemented by combining (e.g., concatenating) the query parameters with the predetermined secret 202 and applying a cryptographically secure hash function (e.g., SHA-256). The hash value serves as a seed for a pseudorandom number generator, producing a fraction uniformly distributed between 0 and 1. To guard against length extension attacks and potential collisions, HMAC with SHA-256 (HMAC-SHA256) may be used, though simpler hash functions might be preferred for computational efficiency. The predetermined secret 202 ensures that even with knowledge of the algorithm and query parameters, an attacker cannot compute the noise value.

The predetermined secret 202 serves as a key to ensure the unpredictability and security of the noise values. This secret 202 may be generated using a cryptographically secure random number generator (CSPRNG) to produce a sufficiently long and unpredictable string of bits. This could be achieved using cryptographic libraries or secure system functions designed for this purpose. The length of the secret 202 may be adequate to prevent brute-force attacks, such as, for example, at least 256 bits. Once generated, this secret 202 may be securely stored and managed, with access strictly limited to only the necessary parts of the system. The secret 202 may remain constant for a given deployment of the algorithm to ensure consistency in noise generation across queries. However, the secret 202 may be rotated periodically (e.g., annually) as a security best practice, with careful consideration given to maintaining backwards compatibility for historical data analysis. The method of generation and storage may comply with relevant security standards and best practices for cryptographic key management.

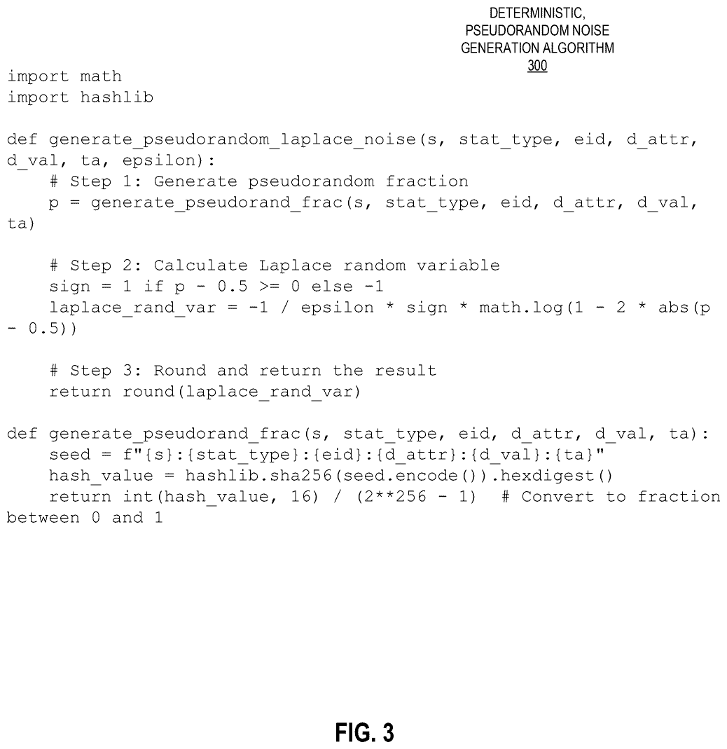

FIG. 3 illustrates an example pseudocode implementation of a deterministic, pseudorandom noise generation algorithm for generating a noise value for an input predetermined secret, a query, and a privacy parameter, according to some embodiments of the present disclosure. The example pseudocode implementations provided herein and in the drawings are merely examples used to illustrate various embodiments of the disclosed techniques such that one skilled in the art can understand how to make and use the disclosed techniques. Various implementation details (e.g., such as authentication, authorization, and auditing mechanisms) may be omitted from the example pseudocode to avoid unnecessary obscuring the disclosed techniques.

The pseudocode 300 implements a pseudorandom Laplace noise generation algorithm. The main function, generate_pseudorandom_laplace_noise, takes seven parameters: a secret value s, statistical query details (stat_type, eid, d_attr, d_val, ta), and a privacy parameter epsilon.

The function first calls generate_pseudorand_frac to produce a deterministic pseudorandom fraction between 0 and 1. This fraction is then used to generate Laplace-distributed noise. The algorithm calculates the sign based on whether the fraction is above or below 0.5, then applies the inverse cumulative distribution function (CDF) of the Laplace distribution. This is done using the formula −1/epsilon*sign*math.log(1−2*abs(p−0.5)), where epsilon is the privacy parameter controlling the scale of the noise. The resulting value is rounded to the nearest integer to ensure the output is a whole number, suitable for noisy count reporting.

The generate_pseudorand_frac function implements the deterministic pseudorandom fraction generation. It concatenates all input parameters into a single string, separated by colons. This string is then hashed using SHA-256, a cryptographically secure hash function. The resulting hash is interpreted as a hexadecimal number and divided by 2**256-1 to produce a fraction between 0 and 1. This approach ensures that identical inputs always produce the same pseudorandom fraction, while making it computationally infeasible for an attacker to predict or reverse-engineer the output without knowing the predetermined secret 202.

This implementation addresses the key requirements of the algorithm: it provides differential privacy through Laplace noise, ensures consistency for repeated queries by using deterministic pseudorandom generation, and maintains security against potential attacks on the noise generation process through the use of cryptographic hashing and a secret value.

As an example, consider the following canonical representation of a SQL-like statistical query: SELECT COUNT(*) FROM table(stat_type, eid) WHERE timeStamp >=startTime AND timeStamp <=endTime AND d_attr=d_val.

The query represents a statistical query that aligns with the input parameters of the generate_pseudorandom_laplace_noise function in the given pseudocode 300. This SQL-like query is designed to count records from a table, filtered by specific criteria that correspond to the function's parameters.

In the context of the pseudocode 300, stat_type and eid are used to identify the specific table or data subset being queried. The WHERE clause includes a time range filter (timeStamp>=startTime AND timeStamp<=endTime) which corresponds to the ta (atomic time range) parameter in the function. The atomic time range is described in greater detail below. The constraint that startTime and endTime map to the atomic time range ensures that the query's time scope aligns with the granularity expected by the noise generation algorithm.

The d_attr=d_val condition in the query directly relates to the d_attr and d_val parameters in the function, representing a specific demographic attribute and its value being filtered. These parameters, along with s (the secret value, not visible in the query but used for the noise generation), are all used in the generate_pseudorand_frac function to create a deterministic pseudorandom fraction.

This query structure allows for the generation of consistent noise for repeated queries with the same parameters, as the noise generation is based on these specific query characteristics. When this query is executed, the true count would be calculated, and then the noise generated by generate_pseudorandom_laplace_noise would be added to this count to provide a differentially private result. The use of these specific parameters ensures that the same query will always receive the same noise value, maintaining consistency while protecting privacy through the addition of Laplace noise.

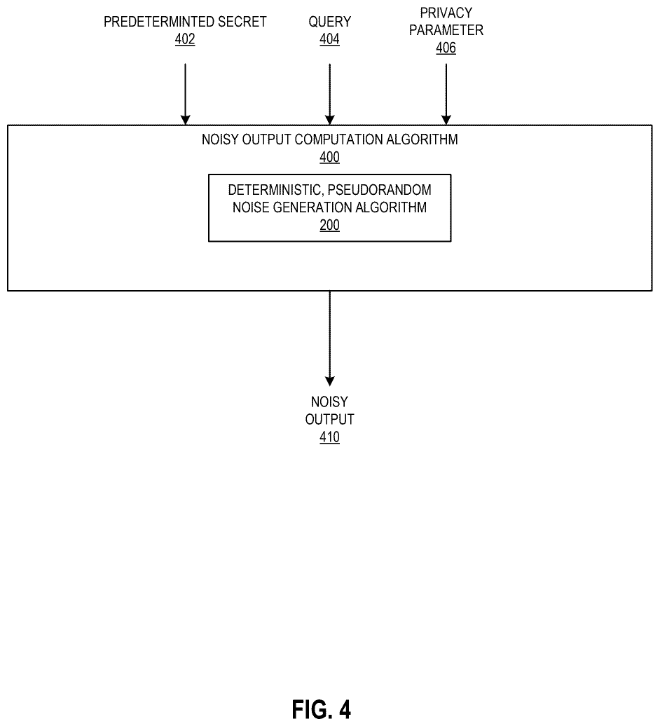

FIG. 4 is a black box view of a noisy count computation algorithm 400, according to some embodiments of the present disclosure. Algorithm 400 computes differentially private statistics for aggregation queries of a predetermined type. It takes several inputs: a predetermined secret 402, a query 404, and a privacy parameter (epsilon) 406. While in this example, the aggregation query involves a COUNT( ) query aggregation function or the like, as indicated above, algorithm 400 can be adapted to work any suitable query aggregation function such as SUM( ), SUM( ), AVG( ), MIN( ), MAX( ), VAR( ) or VARIANCE( ), STDEV( ) or STDDEV( ), GROUPING( ), GROUPING_ID( ), or any other suitable query aggregation function. Such adaptation may involve computing true output of the query 404 (e.g., the result of the query aggregation function as used in the query 404) and combining the true output with noise to generate and return a noise output.

The algorithm 400 operates in three main steps. First, it computes the true output for the given query 404. This step may involve querying an underlying database or data structure or accessing a database cache.

Next, the algorithm generates pseudorandom Laplace noise by calling a method, function, or procedure that implements the deterministic, pseudorandom noise generation algorithm 200 of FIG. 2. This method, function, or procedure uses all the input parameters to ensure the noise is deterministic for repeated identical queries, yet unpredictable without knowledge of the secret 402.

The algorithm adds the generated noise to the true output. To maintain consistency and non-negativity of results, it returns the maximum of this sum and zero. This ensures that even if the noise pushes the count into negative territory, a non-negative result is always returned.

This approach achieves several goals in differential privacy: it adds calibrated noise to protect individual privacy, ensures consistency for repeated queries, and maintains non-negativity of count statistics. The use of a fixed secret and deterministic noise generation also provides security against attempts to average out the noise through repeated queries.

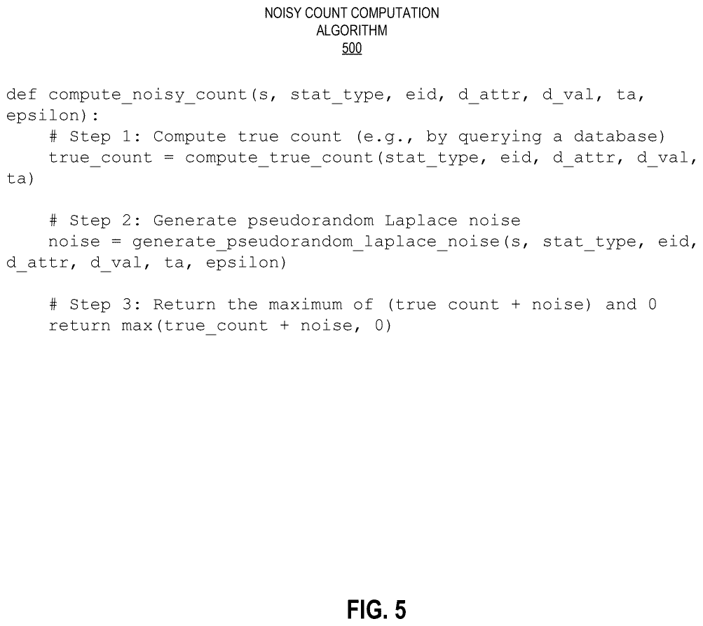

FIG. 5 illustrates an example pseudocode 500 implementation of a noisy count computation algorithm, according to some embodiments of the present disclosure. This function takes seven parameters: a secret value s, statistical query details (stat_type, eid, d_attr, d_val, ta), and a privacy parameter epsilon.

The function operates in three main steps. First, it calls compute_true_count to obtain the actual count from the underlying data source. Its implementation would depend on the specific database or data structure being used. As a practical matter, this would involve executing a query such as the example SQL query above, with the time range constrained to the atomic time range ta. The atomic time range parameter ta is described in greater detail below.

Next, the function calls generate_pseudorandom_laplace_noise function of FIG. 3. This function generates a deterministic, pseudorandom noise value from a Laplace distribution, using the provided parameters. The use of consistent parameters ensures that the same query will always receive the same noise value, maintaining consistency across repeated queries.

The function adds the generated noise to the true count and uses the max function to ensure the result is non-negative. By never returning a negative count, the function ensures that aggregated counts over longer time periods (which could be computed by summing the results of multiple canonical queries) will never decrease.

This implementation effectively provides differential privacy by adding calibrated noise to the true count, while also ensuring consistency and non-negativity of the reported statistics. The use of a secret value and deterministic noise generation allows for repeatability of results for identical queries, which is useful for scenarios like analytics dashboards where users might repeatedly view the same data.

In some embodiments, the atomic time range ta corresponds to the time range in the query (e.g., the time range corresponding to startTime and endTime in the example query). In some embodiments, the atomic time range parameter ta represents the smallest, indivisible unit of time for which statistics are computed and noise is added.

In some embodiments, atomic time ranges are defined within a fixed hierarchy of time ranges. For example, a hierarchy might be structured as 3-hour epochs, days, months, quarters, and years. In this context, an atomic time range is any range that exactly maps to a level in this hierarchy. For instance, a 3-hour period from 12:00 AM to 3:00 AM, a full day, or a complete month would be valid atomic time ranges.

The use of atomic time ranges provides a basis for partitioning arbitrary query time ranges into a set of atomic ranges, allowing for consistent noise addition across different queries. It helps bound the privacy loss by limiting the number of queries that can involve any single event, as each event only contributes to a fixed number of atomic time ranges (equal to the number of levels in the time hierarchy). It protects against potential averaging attacks where an attacker might try to reduce noise by splitting a time range and averaging results. It allows for a balance between query flexibility, consistency over time, and privacy preservation.

In some embodiments, when a query spans multiple atomic time ranges, the query range may be partitioned into the minimal set of atomic ranges, noisy outputs computed for each minimal range, and then results summed. This approach provides better utility for longer time range queries while partially sacrificing strict consistency over time in favor of enhanced privacy protection.

The pseudorandom Laplace noise generation algorithm 200 does not take into account changes in the underlying database between repeated queries because it is designed to be deterministic and data-independent. This algorithm generates noise based on the input parameters: the fixed secret (s), statistics type (stat_type), entity ID (eid), demographic attribute-value pair (d_attr, d_val), atomic time range (ta), and privacy parameter (epsilon).

An aspect of this design is the use of a deterministic pseudorandom function (GeneratePseudorandFrac) that always produces the same output for a given set of inputs. This function doesn't query the database or incorporate any information about the current state of the data. Instead, it uses cryptographic techniques (likely a hash function, as seen in the pseudocode 300 implementation) to generate a consistent pseudorandom value based on the input parameters.

As a result, if the same query parameters are used (e.g., the same combination of s, stat_type, eid, d_attr, d_val, ta, and epsilon), the algorithm 200 will generate identical noise regardless of whether the underlying data has changed. This property ensures consistency in the noise added to repeated queries, which is useful for certain use cases like maintaining consistent results in analytics dashboards over time.

However, this approach also means that the noise doesn't adapt to changes in the database. The privacy protection offered by the noise remains constant, even if the true count in the database has significantly changed. This could potentially lead to situations where the added noise is disproportionately large or small compared to the current true count, depending on how much the data has changed since the query was first run.

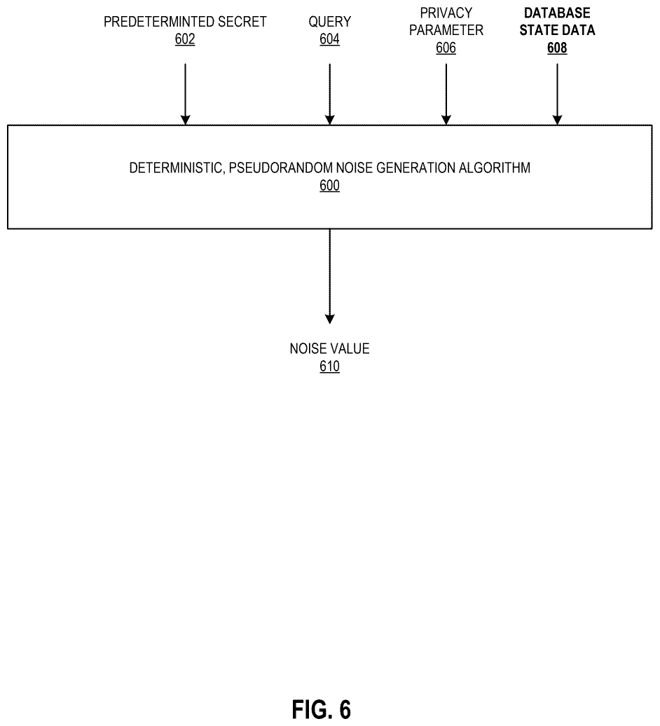

FIG. 6 is a black box view of a modified version 600 of algorithm 200 of FIG. 2 that accepts an additional input parameter “state_data,” according to some embodiments of the present disclosure. The additional input parameter enhances the algorithm 600's ability to generate pseudorandom Laplace noise that is sensitive to the current state of the database. This modification alters the GeneratePseudorandomLaplaceNoise function to include state_data as an input alongside the existing parameters: fixed secret (s), statistics type (stat_type), entity ID (eid), demographic attribute-value pair (d_attr, d_val), atomic time range (ta), and privacy parameter (epsilon).

In this modified version 600, the GeneratePseudorandFrac function may incorporate the state_data into its computation. This could be achieved by including state_data in the seed used for the pseudorandom number generation. For example, if using a cryptographic hash function, state_data may be concatenated with the other parameters before hashing. This ensures that any changes in the database state would result in a different pseudorandom fraction, even if all other parameters remain the same.

The rest of the algorithm 600 may remain largely unchanged. The pseudorandom fraction may still be transformed into a Laplace-distributed random variable using the inverse cumulative distribution function, and the result would be rounded to the nearest integer. However, because the initial pseudorandom fraction now depends on the database state, the noise value would also reflect any changes in the underlying data.

This modification allows the algorithm 600 to generate consistent noise for repeated queries when the database state hasn't changed, while also adapting the noise when the data does change. This approach maintains the benefits of deterministic noise generation (such as consistency for unchanged data and protection against averaging attacks) while also ensuring that the noise remains appropriate and effective as the database evolves over time. It strikes a balance between privacy protection, query result consistency, and sensitivity to data changes, making it suitable for dynamic database environments where both privacy and accurate reflection of current data states are important.

The database state data parameter 608 in the modified algorithm 600 represents information that captures the current state of the database table at the time of query execution. This data serves as a fingerprint of the table's contents, allowing the noise generation process to adapt to changes in the underlying data. Some example approaches of how the database state data parameter 608 could be determined as described below.

### Last Update Timestamp:

In this approach, the database state data parameter 608 could be a timestamp indicating when the particular database table was last modified. This timestamp may change whenever any insert, update, or delete operation is performed on the table. When used in the noise generation algorithm 600, it ensures that any change to the table, no matter how small, results in a different noise value for subsequent queries. This method is computationally efficient, as it only requires storing and retrieving a single timestamp value. However, it may be overly sensitive, generating new noise even for inconsequential changes that don't affect the query result. This approach may be useful in scenarios where any data change is considered significant enough to warrant new noise generation.

### Hash of Relevant Data:

This more granular approach involves computing a cryptographic hash (e.g., SHA-256) of the specific data used to determine the true output for the query. The database state data parameter 608 in this case would be the resulting hash value. This method may be more precise than the timestamp approach, as it generates new noise when the data relevant to the particular query has changed. It may operate by first executing the query to obtain the true output, then hashing the rows or values that contributed to this output. This hash becomes the database state data parameter 608 input for the noise generation algorithm 600. While more computationally intensive than using a timestamp, this approach provides a more accurate representation of meaningful changes in the data. It may be especially valuable in scenarios where fine-grained control over noise regeneration is necessary, ensuring that noise changes only when query-relevant data has been modified.

Both of these approaches allow the noise generation algorithm 600 to produce consistent results for repeated queries when the underlying data has not changed, while also adapting the noise appropriately when relevant changes occur. The choice between these (or other) the database state data parameter 608 implementations would depend on the specific requirements of the system, balancing factors such as computational efficiency, granularity of change detection, and the nature of the data and queries being handled.

Other examples of database state data parameter 608 that could be used in the modified algorithm 600 include any of or a combination of:

Row Count: The total number of rows in the particular database table may serve as database state data parameter 608. This can change whenever records are added or deleted, but not for updates to existing records. It's simple to compute and provides a basic indicator of data volume changes.

Checksum of Column Values: A checksum (like MD5 or CRC32) of the values in specific columns relevant to the query may be used. This is less computationally intensive than a full hash but still captures changes in the data values.

Bloom Filter of Table Contents: A Bloom filter, which is a space-efficient probabilistic data structure, may be used to represent the contents of the table. It would change as records are added or removed, providing a compact representation of the data state.

Version Number or Incrementing Counter: A version number or counter that increments with each change to the table may be used as database state data parameter 608. This is similar to the timestamp approach but uses a simple integer that increases monotonically.

Combination of Metadata: The database state data parameter 608 could be a combination of multiple metadata elements, such as row count, last update timestamp, and table size in bytes. This provides a more comprehensive view of the table's state.

Merkle Tree Root: For very large tables, a Merkle tree (a tree in which every leaf node is labelled with the hash of a data block, and every non-leaf node is labelled with the cryptographic hash of the labels of its child nodes) could be maintained, with the root hash serving as database state data parameter 608. This allows for efficient updates and verification of large datasets.

Query-Specific Aggregate Values: For certain types of queries, specific aggregate values (like SUM, AVG, or COUNT of particular columns) may serve as database state data parameter 608. This would be sensitive to changes that specifically affect the query results.

Data Distribution Statistics: Summary statistics about the distribution of data in relevant columns (such as min, max, mean, median, or standard deviation) may be used. This would capture changes in the overall characteristics of the data

LSM Tree Metadata: For databases using Log-Structured Merge-Trees, metadata about the current state of the LSM tree (such as the number of levels or the size of the largest level) may serve as database state data parameter 608.

Temporal Aspects: For time-series data, the range of timestamps in the data (minimum and maximum) could be used as database state data parameter 608, capturing the current temporal extent of the dataset.

Each of these approaches has its own trade-offs in terms of computation cost, sensitivity to changes, and appropriateness for different types of data and queries. The choice would depend on the specific requirements of the system and the nature of the data being protected.

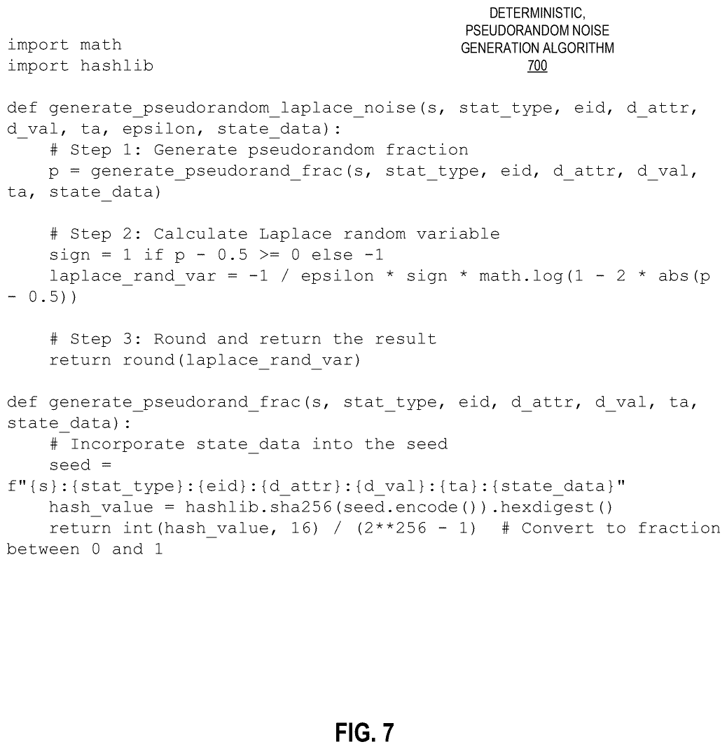

FIG. 7 illustrates a modified version of pseudocode 300 as pseudocode 700, according to some embodiments of the present disclosure. In this modified version, the generate_pseudorandom_laplace_noise function now accepts state_data as an additional parameter. The generate_pseudorand_frac function is updated to include state_data in the seed string used for hashing. The rest of the algorithm 700 remains the same, but now the generated noise will be sensitive to changes in the state_data.

This modification ensures that the noise generation process takes into account the current state of the database. If the state_data changes (indicating a change in the underlying database), it will result in a different pseudorandom fraction and thus a different noise value, even if all other parameters remain the same.

This approach maintains consistency for repeated queries when the database state hasn't changed (as the same state_data will produce the same noise), while also adapting the noise when the data does change (as reflected by a change in state_data).

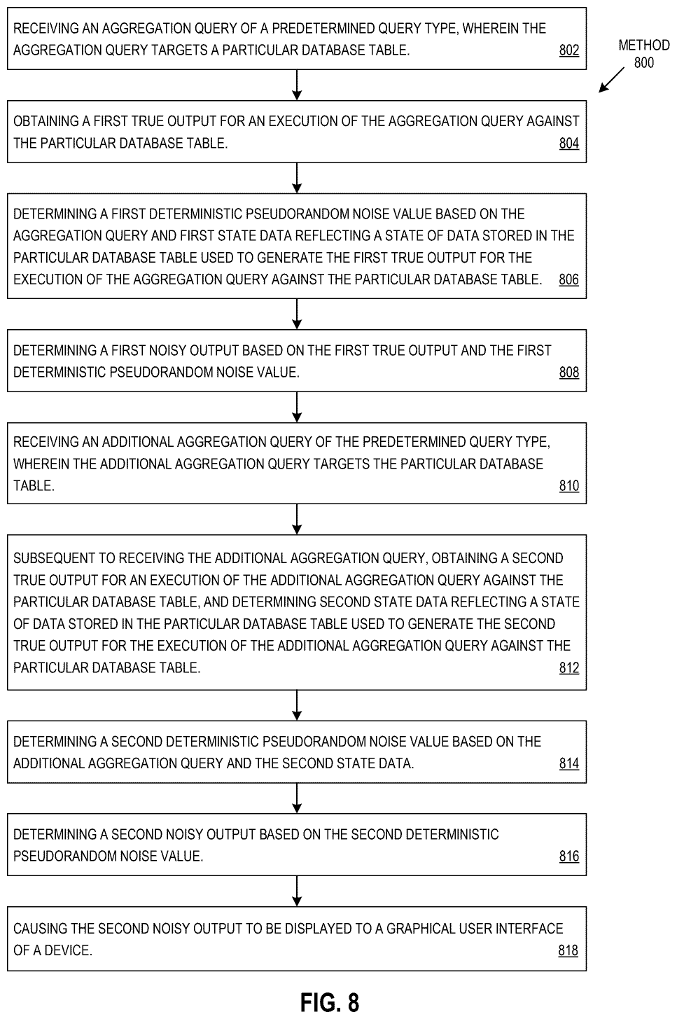

FIG. 8 illustrates a computer-implemented method 800 for executing aggregation queries on a database table while incorporating differential privacy techniques that adapt to potential changes in the underlying data, according to some embodiments of the present disclosure. This method 800 is designed to handle both initial and subsequent queries, accounting for possible alterations in the database state between query executions.

The process 800 begins by receiving an aggregation query of a predetermined type targeting a specific database table (step 802). It then obtains the true output by executing this query against the table (step 804). The method 800 determines a first deterministic pseudorandom noise value based on both the query itself and the current state of the data in the table (step 806). This state data reflects the condition of the database at the time of query execution, allowing the noise generation to be sensitive to the data's current characteristics. The method 800 then combines the true output with this noise to produce a noisy output (step 808), which helps preserve privacy by obscuring the exact query results.

The method 800 then accounts for subsequent queries by following a similar process for an additional aggregation query (step 810). It obtains a new true output and, importantly, determines new state data reflecting any potential changes in the database since the first query (step 812). This updated state data is used along with the new query parameters to generate a second deterministic pseudorandom noise value (step 814). This approach ensures that the noise added to query results remains appropriate and effective even if the underlying data has changed significantly. The method 800 concludes by determining a second noisy output based on this new noise value (step 816) and displaying it in a graphical user interface of a device (step 818).

This approach provides a balance between query result consistency and adaptive privacy protection. By incorporating current state data into the noise generation process, the method 800 can maintain effective differential privacy even as the database contents evolve over time, while still providing deterministic results for identical queries if the database hasn't changed. This makes it particularly suitable for scenarios where data may be frequently updated but where consistent query results are also desirable for unchanged data states.

At step 802 of the method 800, an aggregation query of a predetermined query type is received, targeting a specific database table.

An aggregation query in this context may encompass a query that performs a calculation on a set of values and returns a single result. Common aggregation operations include COUNT, SUM, AVG, MIN, and MAX. For example, a query that counts the number of records meeting certain criteria or calculates the average value of a particular column are examples of an aggregation query.

The predetermined query type may be designed to handle specific, pre-defined categories of queries. The method 800 may be optimized for certain types of aggregation operations or query structures. By limiting the query types, the method 800 can implement tailored privacy-preserving techniques for each type, ensuring efficient and effective noise addition.

The predetermined nature of the query type may allow the system (e.g., online system 105) to have pre-established privacy budgets, noise generation mechanisms, and sensitivity calculations for each query type. This pre-determination can help in maintaining consistent privacy guarantees across different queries of the same type.

The following are some examples of suitable predetermined query types that could be used in the context of method 800

COUNT Queries: These queries return the number of rows that match specific criteria. For example, the COUNT of total post views in the last 24 hours, or the COUNT of unique users who viewed posts in a specific category.

SUM Queries: These aggregate the total of a numeric column for rows meeting certain conditions. For example, the SUM of view durations for video posts in a particular topic, or the SUM of engagement actions (likes, comments, shares) on viewed posts.

AVERAGE Queries: These calculate the mean value of a numeric column. For example, the AVERAGE view time per post for a specific content creator, or the AVERAGE number of post views per active user per day.

MIN/MAX Queries: These return the smallest or largest value in a set. For example, the MAX number of views received by a single post in the last week, or the MIN time to reach 1000 views for posts in a trending category.

DISTINCT COUNT Queries: These count the number of unique values in a column. For example, the DISTINCT COUNT of users who viewed sponsored posts, or the DISTINCT COUNT of content categories viewed by a user segment.

PERCENTILE Queries: These return a value at a specific percentile of a dataset. For example, the 95th PERCENTILE of view counts for posts published today, or the 50th PERCENTILE (median) of time spent viewing posts per session.

GROUP BY Queries with Aggregation: These perform aggregations on groups of data. For example, the COUNT of post views GROUP BY user age group and post category, or the AVERAGE view duration GROUP BY time of day and device type.

HAVING Queries: These filter the results of GROUP BY queries. For example, the COUNT of posts GROUP BY author HAVING view count >10,000, or the AVERAGE engagement rate GROUP BY post type HAVING views >5,000.

Window Function Queries: These perform calculations across a set of rows related to the current row. For example, the RANK of posts based on views within each content category, or the running total of views for a user's posts over the last 30 days.

Time-based Aggregation Queries: These aggregate data over specific time periods. For example, the daily total post views over the past month, or the hourly average view count for trending posts in the last 24 hours.

Step 804 of the method 800 involves obtaining the first true output by executing the received aggregation query against the particular database table. This step represents the actual data retrieval and computation phase before privacy-preserving mechanisms are applied. This step may involve query parsing where the system (e.g., OLAP system 120) interprets the received aggregation query, breaking it down into its constituent parts (e.g., SELECT clause, FROM clause, WHERE conditions, GROUP BY clauses, and any aggregation functions). This step may also involve query optimization where the database management system's query optimizer may analyze the query and determine the most efficient execution plan. This could involve decisions about index usage, join order (if applicable), and aggregation strategies. This step may also involve the system accessing the particular database table specified in the query. This may involve reading data from disk or memory, depending on the database's architecture and current state. If the query includes WHERE conditions, the system may apply these filters to select only the relevant rows from the table. The system may perform the specified aggregation operation(s) on the selected data. This may involve operations like counting rows, summing values, calculating averages, or finding minimum/maximum values. The computed result is assembled into the format specified by the query. The output of this step 804 is referred to as the “first true output” because it represents the actual, unmodified result of the query based on the current state of the database. This true output is what will be used in subsequent steps of the method 800 to generate a privacy-preserving noisy output.

In some database systems, executing an aggregation query against a particular database table may involve more complex data access patterns than simply reading directly from the table. One technique is the use of caching mechanisms, which can improve query performance and reduce load on the primary database.

When a query is executed, the system may first check one or more cache layers before accessing the database table directly. These caches could exist at any or all of the following levels:

Query Result Cache: The system might store the results of frequently executed queries. If the exact same query is received again and the underlying data hasn't changed, the cached result can be returned immediately without re-executing the query.

Materialized View Cache: For common aggregations, the database might maintain pre-computed aggregated data in materialized views. These views can be used to answer queries faster than computing from raw data each time.

In-Memory Data Cache: Modern database systems often keep frequently accessed data in memory. This could include entire tables or specific partitions of data that are queried often.

Distributed Cache: In a distributed system, a caching layer (e.g., Memcached or the like) might be used to store aggregated data across multiple nodes for quick access.

Application-Level Cache: The application issuing the query might maintain its own cache of recent query results.

The system may check these caches in order of decreasing specificity and increasing computational cost. If the required data is found in a cache and is determined to be up-to-date, it can be used to compute the query result without accessing the underlying table directly. If the data is not found in any cache or is determined to be stale, the system would then proceed to access the database table directly, potentially updating the relevant caches with the new data or query result. This caching strategy can significantly reduce query latency and database load, especially for frequently executed queries or those involving large datasets.

Step 806 involves determining a first deterministic pseudorandom noise value based on the aggregation query and first state data. This step may involve gathering first state data that reflects the current state of the particular database table. This could include elements like a hash of the relevant data, a last-update timestamp, row counts, or other metadata that captures the table's state at the time of query execution. The aggregation query may also be analyzed and its parameters (such as the query type, target columns, and filtering conditions) may be extracted. These parameters, along with the state data, may serve as inputs to the noise generation function.

Using the query parameters and state data as seeds, a deterministic pseudorandom number generator may be employed. This ensures that the same inputs (query and state) will always produce the same pseudorandom output. The pseudorandom number is then mapped to a specific noise distribution, e.g., Laplace or Gaussian, based on the sensitivity of the query and the desired privacy guarantees (as determined by the privacy budget or epsilon value). The generated noise may be scaled appropriately based on the query's sensitivity and the privacy parameters to ensure that it provides the required level of privacy protection without unnecessarily degrading the utility of the results. The deterministic nature of this process means that if the exact same query is run on the same unchanged data, it will produce the same noise value. This property prevents privacy budget depletion for repeated queries and protects against certain types of attacks that attempt to average out random noise over multiple queries. However, if the underlying data changes (reflected in different state data), or if the query parameters change, a different noise value will be generated. This adaptability ensures that the privacy protection remains effective as the database evolves over time. This approach strikes a balance between privacy protection, query result consistency, and sensitivity to data changes, making it useful for scenarios where both strong privacy guarantees and reliable, consistent query results are required.

Step 808 involves determining the first noisy output by combining the first true output obtained in step 804 with the first deterministic pseudorandom noise value generated in step 807. This step may involve adding the generated noise value to the true output. Depending on the type of query and the nature of the data, this addition might be straightforward (e.g., adding noise to a count query) or more complex (e.g., adding noise to multiple components of a more complex aggregation). After adding the noise, the system may need to calibrate the result to ensure it remains within valid bounds. For example, for count queries, negative values might be clamped to zero, as negative counts are typically meaningless. Depending on the privacy requirements and the nature of the query, the noisy output might be rounded to the nearest integer or truncated to a certain number of decimal places. This can provide additional privacy protection by reducing the granularity of the output. The system may perform checks to ensure that the noisy output maintains certain logical consistencies. For instance, ensuring that a noisy sum is not less than the largest individual noisy count in a related set of queries. In some implementations, this step might also involve calculating and storing error bounds or confidence intervals for the noisy result, which can be useful for downstream analysis. The resulting first noisy output represents a privacy-preserving version of the true query result. It maintains the general statistical properties of the true data while introducing enough uncertainty to prevent the precise identification of individual contributions to the result. This approach allows the system to provide useful analytical capabilities on sensitive data while offering strong privacy guarantees. The noisy output can be used for various purposes such as generating reports, feeding into machine learning models, or displaying in user interfaces, all while protecting the privacy of individuals in the underlying dataset.

Step 810 involves receiving an additional aggregation query of the predetermined query type, which targets the same particular database table as the initial query. This step may involve receiving a new query request, likely through an API endpoint or a query interface. This could be from the same user session or a different user entirely. The incoming query may be parsed to extract its components (e.g., SELECT clause, WHERE conditions, GROUP BY clauses). The system may validate that this query belongs to one of the predetermined query types that it is designed to handle. The system may identify the specific predetermined query type of this additional query. This may be useful because different query types might have different privacy sensitivities and require different noise generation approaches. The system may confirm that this query is targeting the same particular database table as the previous query. This may be useful for the subsequent steps where the system will compare the current state of the data with the previous state. Any relevant metadata about the query (e.g., user information, timestamp, client application) may be extracted and logged. This may be useful for auditing, debugging, or further privacy analysis. Depending on the system's architecture, the query may be queued for processing or immediately executed.

The aggregation query received in step 802 and the additional aggregation query received in step 810 can be either the same query or different queries. The queries could be the same, with identical parameters, filters, and aggregation functions. This scenario may occur in systems with cached dashboards, scheduled reports, or when users refresh their views. In this case, the method's use of deterministic noise generation can provide consistent results if the underlying data hasn't changed, without compromising privacy. The queries might be of the same type but with different parameters. For example, both could be COUNT queries, but one might count users who logged in today, while the other counts users who logged in yesterday. These queries have the same structure but different time parameters. The queries could use different aggregation functions on the same data. For instance, the first query might calculate the AVG view time of posts, while the second calculates the MAX view time. The queries might request the same type of information but at different levels of granularity. For example, one query might ask for daily active users, while the other asks for monthly active users. Both queries could use the same aggregation function but with different WHERE clauses, effectively querying different subsets of the same table. One query might be a simple aggregation, while the other is a more complex query involving multiple aggregations or sub-queries.

Step 812 involves obtaining a second true output for the additional aggregation query and determining second state data reflecting the current state of the database table. This step may involve executing the additional aggregation query against the particular database table. This may involve parsing the query, optimizing it, and then retrieving and processing the relevant data to compute the aggregation result. The execution may utilize indexes, caches, or other optimization techniques to efficiently produce the result. The step 812 may calculate the unmodified result of the query based on the current state of the database. This second true output may represent the accurate answer to the query before any privacy-preserving noise is added. Concurrent with or immediately following the query execution, the step 812 may determine the current state of the database table. This second state data could include various metrics such as any of: a hash of the relevant data or the entire table, the last update timestamp of the table, row counts or other summary statistics, version numbers or change counters, bloom filters representing the table contents, or any other suitable state data.

The step 812 may compare this second state data with the first state data to detect if any changes have occurred in the database table between the two queries. Depending on the system's architecture, there may be mechanisms in place to ensure that the true output calculation and state data determination are performed atomically or in a consistent state to prevent discrepancies due to concurrent updates. The step 812 may update various caches with the new query result and state data to optimize future similar queries.

Step 814 involves determining a second deterministic pseudorandom noise value based on the additional aggregation query and the second state data. This step may involve analyzing the additional aggregation query to extract relevant parameters such as the query type, target columns, aggregation functions, and any filtering conditions. These parameters may serve as inputs to the noise generation process. The second state data, determined in step 812, may be integrated into the noise generation process. This state data may reflect the current condition of the database table and may ensure that the generated noise is sensitive to changes in the underlying data. Using a combination of the query parameters and state data as seeds, the step 814 may employ a deterministic pseudorandom number generator. This ensures that identical inputs (query and state) will always produce the same pseudorandom output, providing consistency for repeated queries on unchanged data. The generated pseudorandom number may be mapped to a specific noise distribution, e.g., Laplace or Gaussian. The choice of distribution and its parameters may be based on the sensitivity of the query and the desired privacy guarantees, often quantified by a privacy budget or epsilon value. The system may calibrate the noise based on the query's sensitivity and privacy parameters. This calibration may ensure that the noise provides adequate privacy protection without unnecessarily degrading the utility of the query results. The system may perform checks to ensure that the generated noise is consistent with any invariants or logical constraints of the data and query type.

Step 816 involves determining the second noisy output based on the second deterministic pseudorandom noise value generated in step 814. This step may include combining the second true output obtained in step 812 with the second deterministic pseudorandom noise value from step 814. The specific method of combination may depend on the query type and the nature of the data. For simple count or sum queries, this may be straightforward addition or subtraction. For more complex queries, it may involve more sophisticated noise incorporation techniques.

After adding the noise, the step 816 may calibrate the result to ensure it remains within valid bounds and maintains semantic consistency. For count queries, negative values may be clamped to zero. For average queries, the step 816 may ensure that the noisy average falls within the range of possible values. For complex queries involving multiple aggregations, the step 816 may ensure that related noisy outputs maintain logical consistency with each other. Depending on the privacy requirements and the nature of the query, the noisy output may be rounded to the nearest integer or truncated to a certain number of decimal places. This can provide additional privacy protection by reducing the granularity of the output. The step 816 may calculate and attach error bounds or confidence intervals to the noisy output. This can provide users with an understanding of the potential range of the true value, given the added noise. In some implementations, the step 816 may compare this second noisy output with the first noisy output (if available and relevant) to ensure consistency in the reported trends, especially if the underlying data has not changed significantly. The step 816 may attach metadata to the noisy output, such as the privacy parameters used, the query type, or a timestamp, to aid in interpretation and auditing.

At step 818, the second noisy output, determined in step 816, may be displayed to a graphical user interface (GUI) of a device. The noisy output, which may be a raw numerical or structured data format, may need to be formatted appropriately for display. This may involve converting numbers to strings, formatting dates, or structuring the data into a specific format (e.g., JSON, XML) that the GUI can interpret. The formatted data may then be sent to the GUI layer of the application. This may involve passing the data through an API or inter-process communication mechanism, depending on the architecture of the system. The GUI may receive the data and may render it visually. This could involve various types of visual representations including any of: textual display of numbers or statistics, charts or graphs (e.g., bar charts, line graphs, pie charts) visualizing the noisy data, tables or grids displaying multiple data points, interactive elements that allow users to explore the data, or any other suitable virtual representation.

Along with the noisy output, the GUI might display additional context such as any of: the query parameters used, indications that the displayed data is noise-added for privacy reasons, confidence intervals or error bounds, if calculated, timestamps or version information, or any other suitable additional context.

The method 800 provides an approach to executing aggregation queries on a database table while implementing adaptive differential privacy techniques. It begins by receiving an initial aggregation query, obtaining its true output, and generating a deterministic pseudorandom noise value based on both the query and the current state of the database. This noise is then applied to create a privacy-preserving noisy output. The method then handles subsequent queries by repeating this process, potentially with updated state data or repeated or different queries, ensuring that the noise generation adapts to changes in the underlying data and the aggregation queries.

By incorporating state data into the noise generation process, the method 800 may ensure that privacy guarantees remain robust even as the underlying data changes over time. The deterministic nature of the noise generation may allow for consistent results when identical queries are run on unchanged data, improving user experience and data interpretation. The method 800 can handle various predetermined query types, allowing for a wide range of analytical operations while maintaining privacy. By avoiding the need to regenerate noise for repeated queries on unchanged data, the method 800 can conserve computational resources and maintain performance. The consistency in noise for unchanged data may prevent attackers from averaging out the noise through repeated queries. The method 800 may allow for fine-tuning of privacy parameters to balance data utility with privacy protection, adapting to different sensitivity levels of data. The approach 800 may be applied to large-scale systems, as it doesn't require storing all previous queries or noise values. The deterministic nature of the process 800 may allow for easier auditing and verification of the privacy-preserving mechanisms. The method 800 may provide a robust, flexible, and efficient approach to implementing differential privacy in database query systems, addressing challenges associated with maintaining privacy in dynamic data environments while still providing useful and consistent analytical capabilities.

### Example Multi-User Application System

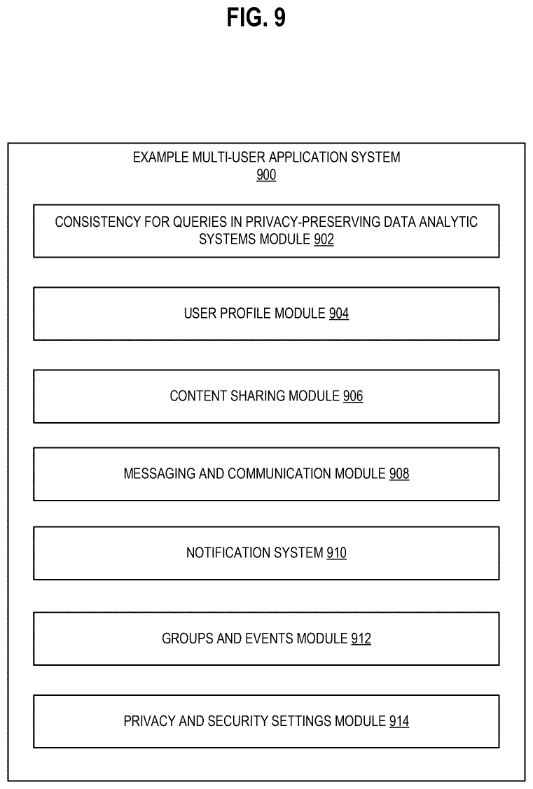

FIG. 9 illustrates an example multi-user application system 900 in which the techniques disclosed herein for consistency for queries in privacy-preserving data analytic systems are implemented, according to some embodiments of the present disclosure.

Example multi-user application system 900 is implemented at least in part by one or more programmable electronic devices (e.g., example programmable electronic device 1000 of FIG. 1000) located or housed in one or more data centers or other physical computer hosting facilities. Example multi-user application system 900 is connected to a data communications network, such as the internet, to interact with (e.g., exchange data with) the programmable electronic devices of users (e.g., smartphones, laptop computers, desktop computers, tablet computers, or other electronic personal computing devices).

Example multi-user application system 900 is an online service, platform, or site that focuses on facilitating the building of social, professional, organizational, community, or governmental networks or relations among people, business, organizations, governments, communities, groups, or other entities (generally “users”). A “member” is a user that uses, interacts, or accesses the example multi-user application system 900 under an established identity such as an identity established via a user authentication process. For example, a member can be a registered user of the example multi-user application system 900 with a verified account that allows the member to access, use, or interact with access-controlled features of the example multi-user application system 900 that are not available to non-member users. For example, in a social networking context, such access-controlled features may include the ability for a member to post, comment, and interact with other members under a recognized identity. Whereas a non-member user may have only limited access such the ability to view member profiles but not the ability to message or connect or other interact with a member.

Example multi-user application system 900 allows members to connect with other members based on shared interests, backgrounds, real-life connections, or activities. Members create personal profiles where they post various types of content, such as text, photos, and videos, and engage with others through features like messaging, commenting, and liking.

Example multi-user application system 900 offers a digital space for members to share their experiences, ideas, and thoughts, fostering communication and interaction across diverse communities. In an embodiment, example multi-user application system 900 offers additional functionalities, such as creating groups, organizing events, and discovering content based on member preferences.

Example multi-user application system 900 is composed of various modules and components, each serving a distinct function to enhance member experience and interaction. One module of example multi-user application system 900 is the consistency for queries in privacy-preserving data analytic systems module 902 configured to perform or implement the techniques disclosed herein for consistency for queries in privacy-preserving data analytic systems. In addition to consistency for queries in privacy-preserving data analytic systems module 902, example multi-user application system 900 includes any or all of the following modules: member profile module 904, content sharing module 906, messaging and communication module 908, notification system 910, groups and events module 912, privacy and security settings module 914, or any other suitable multi-user application system module.

Member profile module 904 allows members to create and manage their personal profiles, providing information about themselves and their interests. The member profile module 904 provides a personal space for members to represent themselves and manage their presence on the platform. This member profile module 904 allows members to create and customize their profiles, which act as their digital identity within the network. In an embodiment, the customization includes adding personal information such as name, profile picture, cover photo, logo, avatar, or a bio that reflects their identity, personality, or interests. In an embodiment, members also share additional details like their location, education, work history, and interests, helping to paint a more comprehensive picture of who they are.

Besides personal information, the member profile module 904 enables members to showcase their activities and content on the platform. This includes a timeline or feed of their posts, photos, videos, and shared content, providing a chronological overview of their activity. Members manage the visibility of these elements, controlling who can see their posts and personal information through privacy settings integrated within the member profile module 904.

Additionally, the member profile serves as a hub for social interactions. It allows others to view the member's information, connect by sending friend requests or follows, and engage with the member's content through likes, comments, and shares. In an embodiment, member profile module 904 also includes features like badges or indicators of achievements and activities, further enriching the member's profile.

The content sharing module 906 allows members to post, share, and interact with various types of content like text, images, and videos. This content sharing module 906 provides the ability for members to upload different types of media, such as text posts, photos, videos, and links to external content. This content sharing module 906 includes member-friendly interfaces for creating and editing posts, with, in an embodiment, tools for adding filters to photos, editing video clips, or formatting text. Once content is shared, it becomes visible to others within the member's network, depending on the member's privacy settings.

Content sharing module 906 also facilitates interaction with this content, allowing viewers to like, comment, and share posts, thus promoting engagement and discussion. In an embodiment, advanced features include tagging other members, adding location data, or incorporating hashtags to categorize content and increase its visibility. Content sharing module 906 integrates with the system 900's algorithms to display content in members' feeds based on relevance, recency, and personal preferences. In an embodiment, module 906 provided analytics to members, especially content creators or businesses, offering insights into the reach and engagement of their posts.

The messaging and communication module 908 facilitates private and group conversations, enabling direct and instant communication among members. This messaging and communication module 908 offers a range of functionalities that support both private and group messaging. For private messaging, members send and receive text messages, photos, videos, and links in a one-on-one setting, similar to a traditional Short Message Service (SMS) but with enhanced multimedia capabilities. In an embodiment, this private messaging supports features like read receipts, typing indicators, and the ability to send voice messages. In addition to private conversations, the messaging and communication module 908 includes group messaging capabilities, allowing multiple members to communicate in a single thread. This is particularly useful for coordinating events, discussing common interests, or staying connected with a circle of friends or colleagues.

Additionally, the notification system 910 keeps users informed about activities related to their profile, such as new follows, comments, or likes. The notification system 910 keeps members informed and engaged with the platform's activities. This notification system 910 functions by sending alerts to members about various interactions and updates related to their profile or content they are interested in. Notifications are triggered by a range of activities, such as when another member likes or comments on their posts, follows their profile, tags them in a photo, or mentions them in a comment. In an embodiment, notifications include alerts about messages received, event reminders, or updates from groups or pages the member follows.

The functionality of notification system 910 is designed to be both informative and non-intrusive. Members can customize their notification settings, choosing what types of alerts they receive and how they are notified, whether through the platform's interface, email, or mobile push notifications. This customization enhances the member experience by allowing members to stay connected with the aspects of the platform they find most relevant, without being overwhelmed by excessive or irrelevant alerts.

In an embodiment, the notification system 910 incorporates smart algorithms to prioritize and sometimes group notifications based on the member's past interactions and preferences. For instance, a member might receive a summarized notification of all the likes on a post instead of separate alerts for each like. This intelligent handling ensures that members are kept up to date with important interactions and events, helping to increase member engagement and encouraging them to interact more frequently with the platform.

For community building, the groups and events module 912 allows the creation and management of interest-based groups and event organization. The groups and events module 912 allows members to create, join, and interact within focused communities based on shared interests, causes, or activities. In an embodiment, these groups range from public, open to anyone, to private, where membership requires approval. Within a group, members post content, engage in discussions, share resources, and collaborate on projects or initiatives. Groups have their own set of rules and moderators to ensure a constructive and respectful environment. This feature is instrumental in connecting individuals with common interests and facilitating deeper, topic-centered interactions.

The events feature of the groups and events module 912 complements the groups features of module 912 by enabling members to create, share, and manage events. Members set up event pages, where they provide details such as date, time, location, and description. These pages become a hub for inviting attendees, sharing updates, and posting event-related content.

The groups and events module 912 includes tools for RSVPs, allowing both organizers and attendees to track who is planning to attend. In an embodiment, events are public or private, and are linked to specific groups or open to the broader network. This feature is particularly valuable for organizing meetups, workshops, conferences, or social gatherings, providing a seamless way to coordinate and communicate with participants.

Together, the groups and events module 912 enhances the social aspect of the networking platform. It encourages members to engage in more meaningful, interest-based interactions and provides tools for organizing and participating in real-world events, thus bridging the gap between online connections and offline activities.

Lastly, the privacy and security settings module 914 is designed to empower members with control over their personal information and interactions on the platform. This privacy and security settings module 914 provides various settings and options that enable members to manage who can view their profile, content, and personal details, as well as who can contact them. Members adjust settings to make their profiles either more public or private, determining the visibility of posts, photos, and friend lists. In an embodiment, members choose to make their content visible to everyone, only to their friends, or to a custom list of specific individuals.

In addition to privacy controls, this privacy and security settings module 914, in an embodiment, includes security features aimed at protecting members' accounts from unauthorized access. In an embodiment, this encompasses options like two-factor authentication, where a member must provide two forms of identification before accessing their account, and alerts for login attempts from unfamiliar devices or locations. In an embodiment, members also report suspicious activity and block or report other members who are harassing or spamming them.

Furthermore, the privacy and security settings module 914 provides tools for members to manage how their data is collected and used by the platform. This includes settings for opting out of certain types of data collection or controlling how their information is used for advertising purposes. By offering these comprehensive privacy and security options, the privacy and security settings module 914 not only safeguards members' personal information and accounts but also enhances their trust and comfort in using the platform, ultimately contributing to a safer and more controlled online environment.

### Example Programmable Electronic Device

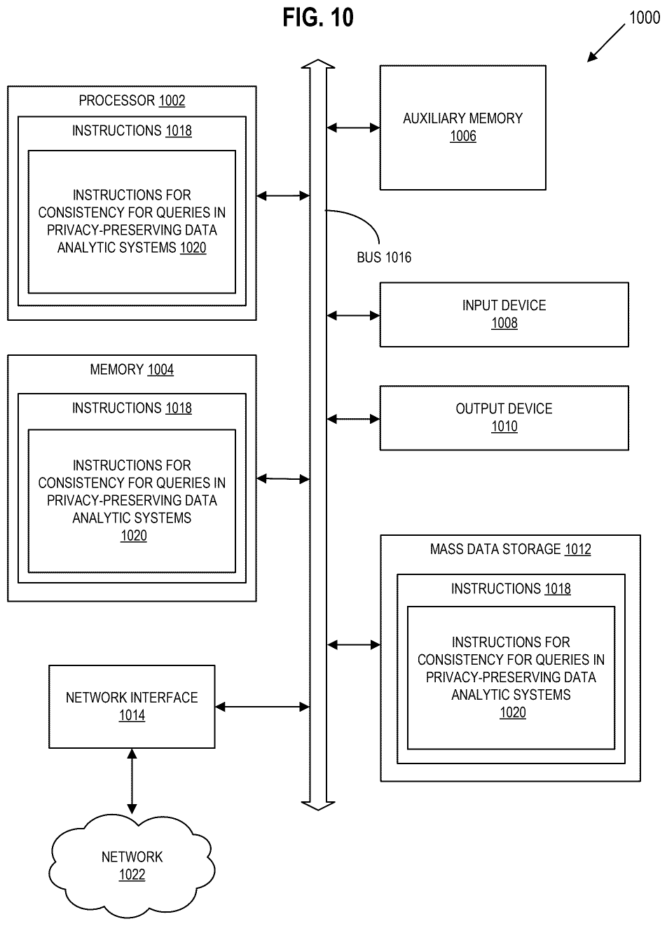

FIG. 10 illustrates an example of an example programmable electronic device that processes and manipulates data to perform the techniques disclosed herein for consistency for queries in privacy-preserving data analytic systems, according to some embodiments of the present disclosure.

Example programmable electronic device 1000 includes electronic components encompassing hardware or hardware and software including processor 1002, memory 1004, auxiliary memory 1006, input device 1008, output device 1010, mass data storage 1012, and network interface 1014, all connected to bus 1016. Network 1022 is connected to, but not a component of, example programmable electronic device 1000.

While only one of each type of component is depicted in FIG. 10 for the purpose of providing a clear example, multiple instances of any or all these electronic components, including possibly multiple different types of instances, are present in example programmable electronic device 1000 in other instances. For example, in an embodiment, multiple processors are connected to bus 1016 such as, for example, one or more Central Processing Units (CPUs) and one or more Graphics Processing Units (GPUs).

Accordingly, unless the context clearly indicates otherwise, reference with respect to FIG. 10 to a component of example programmable electronic device 1000 in the singular such as, for example, processor 1002, is not intended to exclude the plural where, in a particular instance of example programmable electronic device 1000, multiple instances of the electronic component are present. Further, some electronic components might not be present in a particular instance of example programmable electronic device 1000. For example, example programmable electronic device 1000 in a headless configuration such as, for example, when operating as a server racked in a data center, might not include, or be connected to, input device 1008 or output device 1010.

Processor 1002 is an electronic component that processes (e.g., executes, interprets, or otherwise processes) instructions 1018 including instructions 1020 for consistency for queries in privacy-preserving data analytic systems. In an embodiment, processor 1002 fetches, decodes, and executes instructions 1018 from memory 1004 and performs arithmetic and logic operations dictated by instructions 1018 and coordinates the activities of other electronic components of example programmable electronic device 1000 in accordance with instructions 1018. In an embodiment, processor 1002 is made using silicon wafers according to a manufacturing process (e.g., 14 nanometer (nm), 10 nm, 7 nm, 5 nm, or 3 nm). In an embodiment, processor 1002 is configured to understand and execute a set of commands referred to as an instruction set architecture (ISA) (e.g., x86, x86_64, or ARM).

In an embodiment, processor 1002 includes a cache used to store frequently accessed instructions 1018 to speed up processing. In an embodiment, processor 1002 has multiple layers of cache (L₁, L₂, L₃) with varying speeds and sizes.

In an embodiment, processor 1002 is composed of multiple cores where each such core is a processor within processor 1002. The cores allow processor 1002 to process multiple instructions 1018 at once in a parallel processing manner.

In an embodiment, processor 1002 supports multi-threading where each core of processor 1002 handles multiple threads (multiple sequences of instructions) at once to further enhance parallel processing capabilities.

In an embodiment, processor 1002 is any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other type of CPU suitable for the particular implementation at hand.

While processor 1002 might be a CPU, processor 1002, in an embodiment, is any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; specialized hardware for machine learning workloads, especially those involving tensors (multi-dimensional arrays); a field-programmable gate array (FPGA) or other reconfigurable integrated circuit that is customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other type of processor suitable for the particular implementation at hand.

Memory 1004 is an electronic component that stores data and instructions 1018 that processor 1002 processes. In an embodiment, memory 1004 provides the space for the operating system, applications, and data in current use to be quickly reached by processor 1002. In an embodiment, memory 1004 is a random-access memory (RAM) that allows data items to be read or written in substantially the same amount of time irrespective of the physical location of the data items inside memory 1004.

In an embodiment, memory 1004 is a volatile or non-volatile memory. Data stored in a volatile memory is lost when the power is turned off. Data in non-volatile memory remains intact even when the system is turned off. In an embodiment, memory 1004 is Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. In an embodiment, memory 1004 is Static RAM (SRAM). SRAM is volatile memory that is typically faster but more expensive than DRAM. SRAM uses multiple transistors for each memory cell but does not need to be periodically refreshed. Additionally, or alternatively, SRAM is used for cache memory in processor 1002 in an embodiment. In an embodiment, memory 1004 encompasses both DRAM and SRAM.

Example programmable electronic device 1000 has auxiliary memory 1006 other than memory 1004. Examples of auxiliary memory 1006 include cache memory, register memory, read-only memory (ROM), secondary storage, virtual memory, memory controller, and graphics memory. In an embodiment, example programmable electronic device 1000 has multiple auxiliary memories including different types of auxiliary memories.

Cache memory is found inside or very close to processor 1002 and is typically faster but smaller than memory 1004. Cache memory is used to hold frequently accessed instructions 1018 (encompassing any associated data) to speed up processing. In an embodiment, cache memory is hierarchical ranging from Level 1 cache memory which is the smallest but fastest cache memory and is typically inside processor 1002 to Level 2 and Level 3 cache memory which are progressively larger and slower cache memories that are inside or outside processor 1002.

Register memory is a small but very fast storage location within processor 1002 designed to hold data temporarily for ongoing operations.

ROM is a non-volatile memory device that is only read, not written to. In an embodiment, ROM is a Programmable ROM (PROM), Erasable PROM (EPROM), or electrically erasable PROM (EEPROM). In an embodiment, ROM stores basic input/output system (BIOS) instructions which help example programmable electronic device 1000 boot up.

Secondary storage is a non-volatile memory. In an embodiment, secondary storage encompasses any or all of: a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device.

Virtual memory is a portion of a hard drive or an SSD that the operating system uses as if it were memory 1004. When memory 1004 gets filled, less frequently accessed data and instructions 1018 is “swapped” out to the virtual memory. The virtual memory is slower than memory 1004, but it provides the illusion of having a larger memory 1004.

A memory controller manages the flow of data and instructions 1018 to and from memory 1004. The memory controller is located either on the motherboard of example programmable electronic device 1000 or within processor 1002.

Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 1008 is an electronic component that allows users to feed data and control signals into example programmable electronic device 1000. Input device 1008 translates a user's action or the data from the external world into a form that example programmable electronic device 1000 processes. Examples of input device 1008 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 1010 is an electronic component that conveys information from example programmable electronic device 1000 to the user or to another device. The information is in the form of text, graphics, audio, video, or other media representation. Examples of output device 1010 include a monitor or display device, a printer device, a speaker device, a headphone device, a projector device, a plotter device, a braille display device, a haptic device, a LED or LCD panel device, a sound card, and a graphics or video card.

Mass data storage 1012 is an electronic component used to store data and instructions 1018. In an embodiment, mass data storage 1012 is non-volatile memory. Examples of mass data storage 1012 include a hard disk drive (HDD), a solid-state drive (SDD), an optical drive, a flash memory device, a magnetic tape drive, a floppy disk, an external drive, or a RAID array device.

In an embodiment, mass data storage 1012 is additionally or alternatively connected to example programmable electronic device 1000 via network 1022. In an embodiment, mass data storage 1012 encompasses a network attached storage (NAS) device, a storage area network (SAN) device, a cloud storage device, or a centralized network filesystem device.

Network interface 1014 (sometimes referred to as a network interface card, NIC, network adapter, or network interface controller) is an electronic component that connects example programmable electronic device 1000 to network 1022. Network interface 1014 functions to facilitate communication between example programmable electronic device 1000 and network 1022. Examples of a network interface 1014 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 1016 is an electronic component that transfers data between other electronic components of or connected to example programmable electronic device 1000. Bus 1016 serves as a shared highway of communication for data and instructions (e.g., instructions 1018), providing a pathway for the exchange of information between components within example programmable electronic device 1000 or between example programmable electronic device 1000 and another device. Bus 1016 connects the different parts of example programmable electronic device 1000 to each other. In an embodiment, bus 1016 encompasses one or more of: a system bus, a front-side bus, a data bus, an address bus, a control bus, an expansion bus, a universal serial bus (USB), a I/O bus, a memory bus, an internal bus, an external bus, and a network bus.

Instructions 1018 are computer-processable instructions that take different forms. In an embodiment, instructions 1018 are in a low-level form such as binary instructions, assembly language, or machine code according to an instruction set (e.g., x86, ARM, MIPS) that processor 1002 is designed to process. In an embodiment, instructions 1018 include individual operations that processor 1002 is designed to perform such as arithmetic operations (e.g., add, subtract, multiply, divide, etc.); logical operations (e.g., AND, OR, NOT, XOR, etc.); data transfer operations including moving data from one location to another such as from memory 1004 into a register of processor 1002 or from a register to memory 1004; control instructions such as jumps, branches, calls, and returns; comparison operations; and specialization operations such as handling interrupts, floating-point arithmetic, and vector and matrix operations. In an embodiment, instructions 1018 are in a higher-level form such as programming language instructions in a high-level programming language such as Python, Java, C++, etc. In an embodiment, instructions 1018 are in an intermediate level form in between a higher-level form and a low-level form such as bytecode or an abstract syntax tree (AST).

Instructions 1018 for processing by processor 1002 are in different forms at the same or different times. In an embodiment, when stored in mass data storage 1012 or memory 1004, instructions 1018 are stored in a higher-level form such as Python, Java, or other high-level programing language instructions, in an intermediate-level form such as Python or Java bytecode that is compiled from the programming language instructions, or in a low-level form such as binary code or machine code. In an embodiment, when stored in processor 1002, instructions 1018 are stored in a low-level form such as binary instructions, assembly language, or machine code according to an instruction set architecture (ISA). In an embodiment, instructions 1018 are stored in processor 1002 in an intermediate level form or even a high-level form where CPU 1002 processes instructions in such form.

Instructions 1018 are processed by one or more processors of example programmable electronic device 1000 using a processing model such as any or all of the following processing models: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other processing model suitable to meet the requirements of the particular implementation at hand.

Network 1022 is a collection of interconnected computers, servers, and other programmable electronic devices that allow for the sharing of resources and information. Network 1022 ranges in size from just two connected devices to a global network (e.g., the internet) with many interconnected devices. In an embodiment, network 1022 encompasses network devices such as routers, switches, hubs, modems, and access points.

Individual devices on network 1022 are sometimes referred to as “network nodes.” Network nodes communicate with each other through mediums or channels sometimes referred to as “network communication links.” The network communication links are wired (e.g., twisted-pair cables, coaxial cables, or fiber-optic cables) or wireless (e.g., Wi-Fi, radio waves, or satellite links). Network nodes follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol).

Network 1022 has a particular physical or logical layout or arrangement sometimes referred to as a “network topology.” Example network topologies include bus, star, ring, and mesh. In an embodiment, network 1022 encompasses any or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

### Terminology

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media isn't just momentarily present and fleeting but has some degree of persistence. For example, instructions stored in RAM, a hard drive, a SSD, an optical disk, a flash drive, or other volatile or non-volatile storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses all of (a) a single processor configured to carry out recitations A, B, and C; (b) multiple processors where each processor is configured to carry out recitations A, B, and C; and (c) a first processor configured to carry out recitation A working in conjunction (e.g., as a team) with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses all of: (a) a single server configured to carry out recitations A, B, and C; (b) multiple servers each configured to carry out recitations A, B, and C; and (c) a first server configured to carry out recitations A and B working in conjunction (e.g., as a team) with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. is either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

### Privacy

In an embodiment, the techniques described herein are implemented with privacy safeguards to protect user privacy. Furthermore, in an embodiment, the techniques described herein are implemented with user privacy safeguards to prevent unauthorized access to personal data and confidential data. The training of the artificial intelligence (“Ar”) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, in an embodiment, users have full control over the visibility of their content and who sees their content, as is controlled via the visibility settings. According to the techniques described herein, in an embodiment, users have full control over the level of their personal data that is shared and distributed between different AI platforms that provide different functionalities. According to the techniques described herein, in an embodiment, users have full control over the level of access to their personal data that is shared with other parties. According to the techniques described herein, personal data provided by users is, in an embodiment, processed to determine prompts when using a generative AI feature at the request of the user, but not to train generative AI models. In an embodiment, users provide feedback while using the techniques described herein, which are used to improve or modify the platform and products. In an embodiment, any personal data associated with a user, such as personal information provided by the user to the platform, is deleted from storage upon user request. In an embodiment, personal information associated with a user is permanently deleted from storage when a user deletes their account from the platform.

According to the techniques described herein, personal data is, in an embodiment, removed from any training dataset that is used to train AI models. The techniques described herein, in an embodiment, utilize tools for anonymizing member and customer data. For example, user's personal data is, in an embodiment, redacted and minimized in training datasets for training AI models through delexicalization tools and other privacy enhancing tools for safeguarding user data. The techniques described herein, in an embodiment, minimize use of any personal data in training AI models, including removing and replacing personal data. According to the techniques described herein, notices are, in an embodiment, communicated to users to inform how their data is being used and users are provided controls to opt-out from their data being used for training AI models.

According to some embodiments, tools are used with the techniques described herein to identify and mitigate risks associated with AI in all products and AI systems. In an embodiment, notices are provided to users when AI tools are being used to provide features.

What is claimed is:

1. A computer-implemented method comprising:
receiving an aggregation query of a predetermined query type, wherein the aggregation query targets a particular database table;
obtaining a first true output for an execution of the aggregation query against the particular database table;
determining a first deterministic pseudorandom noise value based on the aggregation query and first state data reflecting a state of data stored in the particular database table used to generate the first true output for the execution of the aggregation query against the particular database table;
determining a first noisy output based on the first true output and the first deterministic pseudorandom noise value;
receiving an additional aggregation query of the predetermined query type, wherein the additional aggregation query targets the particular database table;
subsequent to receiving the additional aggregation query, obtaining a second true output for an execution of the additional aggregation query against the particular database table, and determining second state data reflecting a state of data stored in the particular database table used to generate the second true output for the execution of the additional aggregation query against the particular database table;
determining a second deterministic pseudorandom noise value based on the additional aggregation query and the second state data;
determining a second noisy output based on the second deterministic pseudorandom noise value; and
causing the second noisy output to be displayed to a graphical user interface of a device.

2. The computer-implemented method of claim 1, wherein:
the additional aggregation query is different from the aggregation query, the additional aggregation query having at least one of:
different query parameters,
a different aggregation function, or
different filtering conditions than the aggregation query; and
the second deterministic pseudorandom noise value is different from the first deterministic pseudorandom noise value due to at least one of:
the difference between the additional aggregation query and the aggregation query, or
a change in the state of data stored in the particular database table between the execution of the aggregation query and the execution of the additional aggregation query.

3. The computer-implemented method of claim 1, wherein:
the additional aggregation query is identical to the aggregation query; and
the second deterministic pseudorandom noise value is identical to the first deterministic pseudorandom noise value;
the second state data is identical to the first state data, indicating that the state of data stored in the particular database table was unchanged between the execution of the aggregation query and the execution of the additional aggregation query; and
the method further comprises:
determining that the second true output is identical to the first true output; and
determining that the second noisy output is identical to the first noisy output.

4. The computer-implemented method of claim 1, wherein:
the second state data is different from the first state data, indicating that the state of data stored in the particular database table has changed between the execution of the aggregation query and the execution of the additional aggregation query;
the second deterministic pseudorandom noise value is different from the first deterministic pseudorandom noise value due to the difference between the second state data and the first state data;
the method further comprises:
detecting the change in the state of data stored in the particular database table by comparing the second state data to the first state data;
determining that the second true output is different from the first true output based on the detected change in the state of data; and
generating the second deterministic pseudorandom noise value using a noise generation function that takes the second state data as an input, thereby adapting the noise to the changed state of the database table.

5. The computer-implemented method of claim 1, wherein:
the second state data is identical to the first state data, indicating that the state of data stored in the particular database table has not changed between the execution of the aggregation query and the execution of the additional aggregation query;
the second deterministic pseudorandom noise value is identical to the first deterministic pseudorandom noise value due to:
the identity between the second state data and the first state data, and
the use of a deterministic noise generation function that produces the same output for identical inputs;
the method further comprises:
determining that the state of data stored in the particular database table was unchanged by comparing the second state data to the first state data; and
reusing the first deterministic pseudorandom noise value as the second deterministic pseudorandom noise value without regenerating the noise, thereby improving computational efficiency.

6. The computer-implemented method of claim 1, further comprising:
maintaining a privacy budget associated with at least one of the aggregation query, the particular database table, or a user of the device;
determining that the additional aggregation query is identical to the aggregation query;
comparing the second state data to the first state data and determining that they are identical, indicating that the state of data stored in the particular database table is unchanged between the execution of the aggregation query and the execution of the additional aggregation query;
in response to determining that the additional aggregation query is identical to the aggregation query and that the second state data is identical to the first state data:
reusing the first deterministic pseudorandom noise value as the second deterministic pseudorandom noise value;
setting the second noisy output to be identical to the first noisy output; and
forgoing any reduction of the privacy budget that would otherwise occur for executing a new query;
whereby the method allows for repeated execution of the same query on unchanged data without consuming additional privacy budget, thus preserving the privacy budget for future queries while maintaining consistent results for unchanged data.

7. The computer-implemented method of claim 1, wherein the predetermined query type comprises at least one of:
a COUNT query that returns a number of rows meeting specified criteria,
a SUM query that calculates a total of values in a specified column,
an AVERAGE query that computes a mean value of a specified column,
a MIN query that returns a minimum value in a specified column,
a MAX query that returns a maximum value in a specified column,
a DISTINCT COUNT query that counts unique values in a specified column,
a PERCENTILE query that returns a value at a specified percentile of a dataset,
a GROUP BY query with aggregation that performs aggregations on grouped data,
a HAVING query that filters results of a GROUP BY query based on aggregate values,
a window function query that performs calculations across a set of table rows related to the current row, or
a time-based aggregation query that aggregates data over specified time periods.

8. The computer-implemented method of claim 1, further comprising:
selecting a probability distribution from a set of predefined distributions, the set comprising at least two of:
a Laplace distribution,
a Gaussian distribution,
a geometric distribution,
a discrete Laplace distribution,
a uniform distribution,
a truncated Laplace distribution,
a truncated Gaussian distribution,
an exponential distribution,
a Cauchy distribution, or
a student's t-distribution; and
wherein determining the first and second deterministic pseudorandom noise values is based on the selecting the probability distribution;
wherein the selection of the probability distribution is based on at least one of:
the predetermined query type,
a sensitivity of the aggregation query or the additional aggregation query,
a desired level of privacy as specified by a privacy parameter,
characteristics of data stored in the particular database table, or a computational efficiency consideration; and
wherein a parameter of the selected probability distribution is determined based on the first state data for the first deterministic pseudorandom noise value and the second state data for the second deterministic pseudorandom noise value, respectively.

9. The computer-implemented method of claim 1, wherein each of the first state data and the second state data comprises at least one of:
a hash value of data stored in the particular database table,
a hash value of a subset of data used to generate a respective true output,
a last update timestamp of the particular database table,
a row count of the particular database table,
a size in bytes of the particular database table,
a checksum of column values relevant to a respective aggregation query,
a Bloom filter representation of contents of the particular database table,
a version number or incrementing counter associated with the particular database table,
a set of summary statistics of data in the particular database table, including at least one of a minimum value, maximum value, mean, median, or standard deviation of one or more columns;
metadata of a log-structured merge-tree associated with the particular database table,
a range of timestamps present in data of the particular database table,
a count of distinct values in one or more columns of the particular database table,
a sketching data structure summarizing contents of the particular database table, or
a combination of two or more of the above data types.

10. The computer-implemented method of claim 1, wherein causing the second noisy output to be displayed to a graphical user interface of a device comprises at least one of:
presenting the second noisy output as a numerical value with a specified number of significant figures or decimal places;
displaying the second noisy output in a chart or graph, wherein the chart or graph is at least one of a bar chart, line graph, pie chart, histogram, scatter plot, or heatmap;
presenting the second noisy output in a table or grid format, optionally alongside other related data or query results;
providing an interactive visualization that allows a user to explore the second noisy output through actions such as zooming, filtering, or drill-down operations;
displaying the second noisy output with accompanying confidence intervals or error bounds that reflect added noise;
presenting the second noisy output alongside the first noisy output to show trends or changes over time;
color-coding or otherwise visually emphasizing the second noisy output based on its value or relationship to predefined thresholds;
displaying the second noisy output with annotations or tooltips that provide context or explanations about a privacy-preserving nature of a result;
providing options for the user to switch between different visual representations of the second noisy output; or
displaying the second noisy output as part of a dashboard that includes multiple privacy-preserved query results.

11. A system comprising:
a set of one or more hardware processors; and
a set of instructions stored on a set of one or more non-transitory computer-readable media and configured to perform:
receiving an aggregation query of a predetermined query type, wherein the aggregation query targets a particular database table;
obtaining a first true output for an execution of the aggregation query against the particular database table;
determining a first deterministic pseudorandom noise value based on the aggregation query and first state data reflecting a state of data stored in the particular database table used to generate the first true output for the execution of the aggregation query against the particular database table;
determining a first noisy output based on the first true output and the first deterministic pseudorandom noise value;
receiving an additional aggregation query of the predetermined query type, wherein the additional aggregation query targets the particular database table;
subsequent to receiving the additional aggregation query, obtaining a second true output for an execution of the additional aggregation query against the particular database table, and determining second state data reflecting a state of data stored in the particular database table used to generate the second true output for the execution of the additional aggregation query against the particular database table;
determining a second deterministic pseudorandom noise value based on the additional aggregation query and the second state data;
determining a second noisy output based on the second deterministic pseudorandom noise value; and
causing the second noisy output to be stored in a database.

12. The system of claim 11, wherein:
the additional aggregation query is different from the aggregation query, the additional aggregation query having at least one of:
different query parameters,
a different aggregation function, or
different filtering conditions than the aggregation query; and
the second deterministic pseudorandom noise value is different from the first deterministic pseudorandom noise value due to at least one of:
the difference between the additional aggregation query and the aggregation query, or
a change in the state of data stored in the particular database table between the execution of the aggregation query and the execution of the additional aggregation query.

13. The system of claim 11, wherein:
the additional aggregation query is identical to the aggregation query; and
the second deterministic pseudorandom noise value is identical to the first deterministic pseudorandom noise value;
the second state data is identical to the first state data, indicating that the state of data stored in the particular database table was unchanged between the execution of the aggregation query and the execution of the additional aggregation query; and
the system further comprises a set of instructions stored on a set of one or more non-transitory computer-readable media and configured to perform:
determining that the second true output is identical to the first true output; and
determining that the second noisy output is identical to the first noisy output.

14. The system of claim 11, wherein:
the second state data is different from the first state data, indicating that the state of data stored in the particular database table has changed between the execution of the aggregation query and the execution of the additional aggregation query;
the second deterministic pseudorandom noise value is different from the first deterministic pseudorandom noise value due to the difference between the second state data and the first state data;
the system further comprises a set of instructions stored on a set of one or more non-transitory computer-readable media and configured to perform:
detecting the change in the state of data stored in the particular database table by comparing the second state data to the first state data;
determining that the second true output is different from the first true output based on the detected change in the state of data; and
generating the second deterministic pseudorandom noise value using a noise generation function that takes the second state data as an input, thereby adapting the noise to the changed state of the database table.

15. The system of claim 11, wherein:
the second state data is identical to the first state data, indicating that the state of data stored in the particular database table has not changed between the execution of the aggregation query and the execution of the additional aggregation query;
the second deterministic pseudorandom noise value is identical to the first deterministic pseudorandom noise value due to:
the identity between the second state data and the first state data, and
the use of a deterministic noise generation function that produces the same output for identical inputs;
the system further comprises a set of instructions stored on a set of one or more non-transitory computer-readable media and configured to perform:
determining that the state of data stored in the particular database table was unchanged by comparing the second state data to the first state data; and
reusing the first deterministic pseudorandom noise value as the second deterministic pseudorandom noise value without regenerating the noise, thereby improving computational efficiency.

16. The system of claim 11, further comprising a set of instructions stored on a set of one or more non-transitory computer-readable media and configured to perform:
maintaining a privacy budget associated with at least one of the aggregation query, the particular database table, or a user of the device;
determining that the additional aggregation query is identical to the aggregation query;
comparing the second state data to the first state data and determining that they are identical, indicating that the state of data stored in the particular database table is unchanged between the execution of the aggregation query and the execution of the additional aggregation query;
in response to determining that the additional aggregation query is identical to the aggregation query and that the second state data is identical to the first state data:
reusing the first deterministic pseudorandom noise value as the second deterministic pseudorandom noise value;
setting the second noisy output to be identical to the first noisy output; and
forgoing any reduction of the privacy budget that would otherwise occur for executing a new query.

17. A set of one or more non-transitory computer-readable media storing instructions which, when processed by a set of one or more processors, cause:
receiving an aggregation query of a predetermined query type, wherein the aggregation query targets a particular database table;
obtaining a first true count for an execution of the aggregation query against the particular database table;
determining a first deterministic pseudorandom noise value based on the aggregation query and first state data reflecting a state of data stored in the particular database table used to generate the first true count for the execution of the aggregation query against the particular database table;
determining a first noisy count based on the first true count and the first deterministic pseudorandom noise value;
receiving an additional aggregation query of the predetermined query type, wherein the additional aggregation query targets the particular database table;
subsequent to receiving the additional aggregation query, obtaining a second true count for an execution of the additional aggregation query against the particular database table, and determining second state data reflecting a state of data stored in the particular database table used to generate the second true count for the execution of the additional aggregation query against the particular database table;
determining a second deterministic pseudorandom noise value based on the additional aggregation query and the second state data;
determining a second noisy count based on the second deterministic pseudorandom noise value; and
causing the second noisy count to be displayed to a graphical user interface of a device.

18. The set of one or more non-transitory computer-readable media of claim 17, wherein the additional aggregation query is different from the aggregation query, the additional aggregation query having at least one of:
different query parameters,
a different aggregation function, or
different filtering conditions than the aggregation query; and
wherein the second deterministic pseudorandom noise value is different from the first deterministic pseudorandom noise value due to at least one of:
the difference between the additional aggregation query and the aggregation query, or
a change in the state of data stored in the particular database table between the execution of the aggregation query and the execution of the additional aggregation query.

19. The set of one or more non-transitory computer-readable media of claim 17, wherein:
the additional aggregation query is identical to the aggregation query; and
the second deterministic pseudorandom noise value is identical to the first deterministic pseudorandom noise value;
the second state data is identical to the first state data, indicating that the state of data stored in the particular database table was unchanged between the execution of the aggregation query and the execution of the additional aggregation query; and
the set of one or more non-transitory computer-readable media further stores instructions which, when processed by a set of one or more processors, cause:
determining that the second true count is identical to the first true count; and
determining that the second noisy count is identical to the first noisy count.

20. The system of claim 11, wherein:
the second state data is different from the first state data, indicating that the state of data stored in the particular database table has changed between the execution of the aggregation query and the execution of the additional aggregation query;
the second deterministic pseudorandom noise value is different from the first deterministic pseudorandom noise value due to the difference between the second state data and the first state data;
the set of one or more non-transitory computer-readable media further stores instructions which, when processed by a set of one or more processors, cause:
detecting the change in the state of data stored in the particular database table by comparing the second state data to the first state data;
determining that the second true output is different from the first true count based on the detected change in the state of data; and
generating the second deterministic pseudorandom noise value using a noise generation function that takes the second state data as an input.
